(19) United States
(12) Patent Application Publication
(10) Pub. No.: US 2013/0313338 A1
(43) Pub. Date: Nov. 28, 2013

(54) Hopper Gun

(71) Applicant: Davey Z. Liang, Rancho Santa Fe, CA (US)

(72) Inventor: Davey Z. Liang, Rancho Santa Fe, CA (US)

(73) Assignee: Shining Golden Yida Welding & Cutting Machinery Manufacture Ltd., Hong Kong (CN)

(21) Appl. No.: 13/481,576

(22) Filed: May 25, 2012

(51) Int. Cl. B05B 7/30

(52) U.S. Cl. 239/310; 239/379

(57) ABSTRACT

A hopper gun for applying material to a surface has an applicator for applying material, a hopper for supplying material to the applicator, and a connector, connectable to the hopper via a hopper neck, connectable to the applicator via an applicator neck, and configured for establishing communication between the hopper and the applicator, whereby the material may be supplied from the hopper to the applicator. The connector may be flexible, such that the orientation of the applicator and the orientation of the hopper may be varied with respect to one another. The applicator neck and the hopper neck may each have ridges. The connector may have a height and first, second and third cross-sections at three points along the height, respectively, the first, second and third cross-sections having first, second and third exterior perimeters, respectively, and the first, second and third exterior perimeters each having a different length.

### CROSS-REFERENCE TO RELATED APPLICATIONS

Not applicable.

### TECHNICAL FIELD OF THE PRESENT DISCLOSURE

The present disclosure relates in general to hopper guns. More particularly, this disclosure pertains to a hopper gun having an improved connection between the hopper assembly and the gun assembly.

### BACKGROUND OF THE PRESENT DISCLOSURE

A hopper gun may be used, for example, to apply a material to a surface. For example, a hopper gun may be used to spray an aesthetic or functional (e.g., protective or acoustic) textured material on a wall or ceiling of a residential or non-residential building. Using a conventional hopper gun, it may be difficult to apply a material to a ceiling or to a surface in a tight space, e.g., a corner between walls, because the hopper assembly thereof is generally large and hence tends to impede optimal positioning of the gun for application of the material. In this respect, suboptimal positioning may result in aesthetically and/or functionally unacceptable application of the material on the surface, as well as excessive spillage of the material, requiring clean up and perhaps reapplication of the material, hence causing waste of material, waste of time, and frustration on the part of the user. It is noted that reducing the size of the hopper to solve this problem is generally not desirable because a large hopper is preferred in order that the hopper accommodate a large amount of material so as to minimize the frequency with which the hopper needs to be refilled. Another problem that may arise during use of conventional hopper guns is that the hopper assembly and gun assembly may become detached from one another, again leading to spillage and, hence, wasted material, wasted time to reattach, and frustration. It would be advantageous to have a hopper gun in which these problems were resolved or mitigated, to facilitate application of materials on ceilings and in tight spaces and to improve efficiency of operation.

### SUMMARY OF THE PREFERRED EMBODIMENTS

According to a first aspect of the invention, there is provided a hopper gun for applying material to a surface, comprising an applicator, for applying material to a surface; a hopper, for supplying the material to the applicator; and a connector, connectable to the hopper, connectable to the applicator, and configured for establishing communication between the hopper and the applicator, whereby the material may be supplied from the hopper to the applicator. The connector is flexible, such that the orientation of the applicator and the orientation of the hopper may be varied with respect to one another.

According to a second aspect of the invention, there is provided a hopper gun for applying material to a surface, comprising: an applicator, for applying material to a surface; a hopper, for supplying the material to the applicator; and a connector, configured for establishing communication between the hopper and the applicator, whereby the material may be supplied from the hopper to the applicator. The applicator has an applicator neck, and the hopper has a hopper neck, and at least one of the applicator neck and the hopper neck has a ridged portion having one or more ridges. The connector is configured for connection to the applicator neck and the hopper neck, including the at least one ridged portion thereof.

According to a third aspect of the invention, there is provided a hopper gun for applying material to a surface, comprising: an applicator, for applying material to a surface; a hopper, for supplying the material to the applicator; and a connector, configured for establishing communication between the hopper and the applicator, whereby the material may be supplied from the hopper to the applicator. The connector has a height and first, second and third cross-sections at three points along the height, respectively, the first, second and third cross-sections having first, second and third exterior perimeters, respectively, and the first, second and third exterior perimeters each having a different length.

According to other aspects of the invention, hopper guns having other characteristics and features are provided, and methods of using a hopper gun are provided.

### BRIEF DESCRIPTION OF THE DRAWINGS

The following figures form part of the present specification and are included to further demonstrate certain aspects of the present claimed subject matter, and should not be used to limit or define the present claimed subject matter. The present claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIG. 1 is a schematic diagram showing a perspective view of a hopper gun, in accordance with some embodiments of the present disclosure;

FIG. 2 is a schematic diagram showing an exploded, perspective view of a hopper gun, in accordance with some embodiments of the present disclosure;

FIG. 3 is a schematic diagram showing a perspective view of a gun assembly of a hopper gun, but without the neck of the gun assembly, in accordance with some embodiments of the present disclosure;

FIG. 4 is a schematic diagram showing a fragmentary, close-up, exploded perspective view of a portion of the hopper gun shown in FIG. 2, the illustrated portion including the connector, the neck of the hopper assembly, the neck of the gun assembly, and associated elements of the hopper gun pertaining to the connection of the hopper assembly and the gun assembly, in accordance with some embodiments of the present disclosure;

FIG. 5 is a schematic diagram showing a cutaway, or cross-sectional, view, of a portion of an applicator or gun assembly of a hopper gun, including inter alia, an applicator neck having a ridged portion containing ridges, the applicator neck being cut along the longitudinal axis thereof, in accordance with some embodiments of the present disclosure;

FIG. 6 is a schematic diagram showing a cutaway, or cross-sectional, view, of a hopper of a hopper gun, including inter alia, a hopper neck having a ridged portion containing ridges, the hopper neck being cut along the longitudinal axis thereof, in accordance with some embodiments of the present disclosure;

FIG. 7 is a schematic diagram showing a cutaway, or cross-sectional, view, of a connector of a hopper gun, the connector being cut along the longitudinal axis thereof and showing, inter alia, a portion of the interior thereof, in accordance with some embodiments of the present disclosure;

FIG. 8 is a schematic diagram showing a cutaway, or cross-sectional, view, of a connector of a hopper gun, the connector being, cut along the longitudinal axis thereof and showing, inter alia, a portion of the interior thereof, wherein the connector has ridges on the exterior perimeter thereof, in accordance with some alternative embodiments of the present disclosure;

FIGS. 9A, 9B and 9C are schematic diagrams illustrating use of a hopper gun, showing a portion of the hopper gun, with the trigger of the gun assembly in three different positions, respectively, in accordance with some embodiments of the present disclosure;

FIG. 10 is a schematic diagram illustrating use of a hopper gun in a tight space, showing flexing of the connector, whereby the orientation of the hopper assembly and the orientation of the gun assembly are varied relative to one another to facilitate access to the tight space, and also showing the design of the feed opening in the top of the hopper, whereby the likelihood of spilling of the hopper contents is reduced when the hopper is shifted rearward relative to the gun assembly, in accordance with some embodiments of the present disclosure; and

FIG. 11 is a schematic diagram illustrating use of a hopper gun to apply material to a ceiling, showing flexing of the connector, whereby the orientation of the hopper assembly and the orientation of the gun assembly are varied relative to one another to facilitate application of the material on the ceiling, and also showing the design of the feed opening in the top of the hopper, whereby the likelihood of spilling of the hopper contents is reduced when the hopper is shifted rearward relative to the gun assembly, in accordance with some embodiments of the present disclosure.

### DETAILED DESCRIPTION OF ONE OR MORE EMBODIMENTS

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness.

While various embodiments are described herein, it should be appreciated that the present invention encompasses many inventive concepts that may be embodied in a wide variety of contexts. The following detailed description of exemplary embodiments, read in conjunction with the accompanying drawings, is merely illustrative and is not to be taken as limiting the scope of the invention, as it would be impossible or impractical to include all of the possible embodiments and contexts of the invention in this disclosure. Upon reading this disclosure, many alternative embodiments of the present invention will be apparent to persons of ordinary skill in the art. The scope of the invention is defined by the appended claims and equivalents thereof.

Illustrative embodiments of the invention are described below. In the interest of clarity, not all features of an actual implementation are described in this specification. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure.

With regard to terminology, the use of the term “preferable” or “preferably” is to be understood as indicating, inter alia, that the stated matter need not be as stated and that alternatives and contraries to the stated matter may obtain, unless indicated otherwise. For example, if it were stated that a widget preferably has a certain characteristic, it is thereby indicated that the widget may also not have the certain characteristic, may have a different or contrary characteristic, etc., unless indicated otherwise. In this regard, it could be the case that, within a given embodiment, an element may not be able to have a contrary characteristic, but that in a different embodiment, the element can have the contrary characteristic. Nonetheless, unless indicated otherwise, different embodiments are combinable with one another (combinations of more than two embodiments being possible), and any number of features of different embodiments are combinable with one another.

The structure and operation of a hopper gun according to preferred embodiments will be described with reference to the figures.

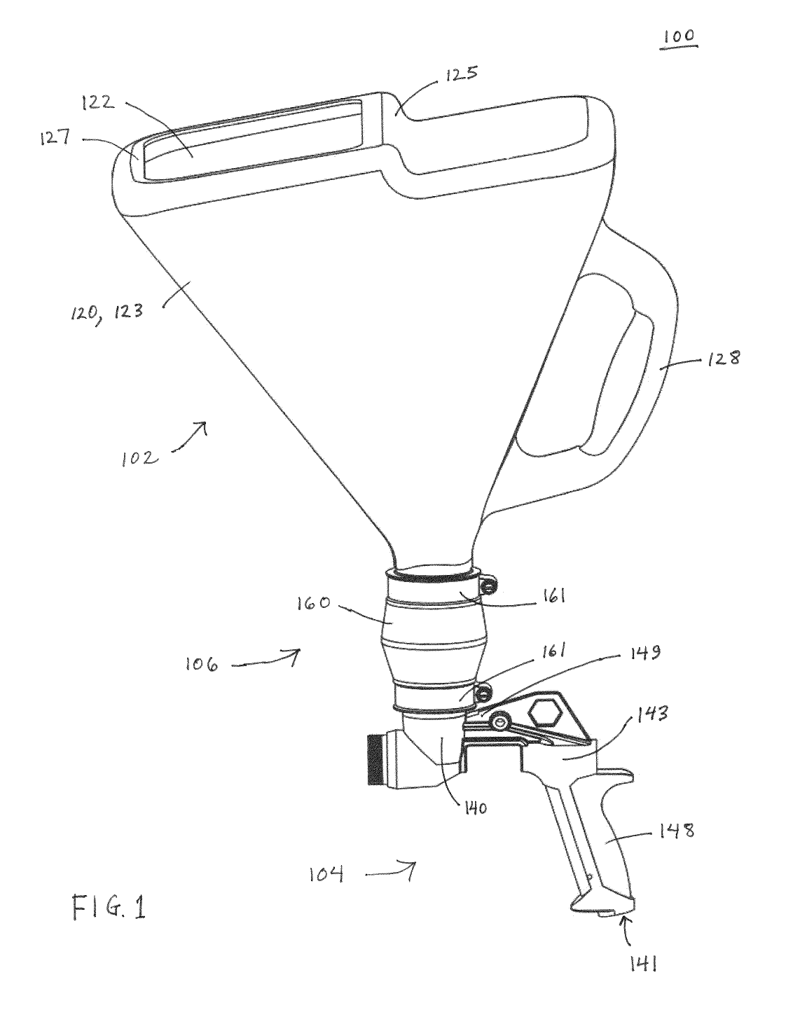

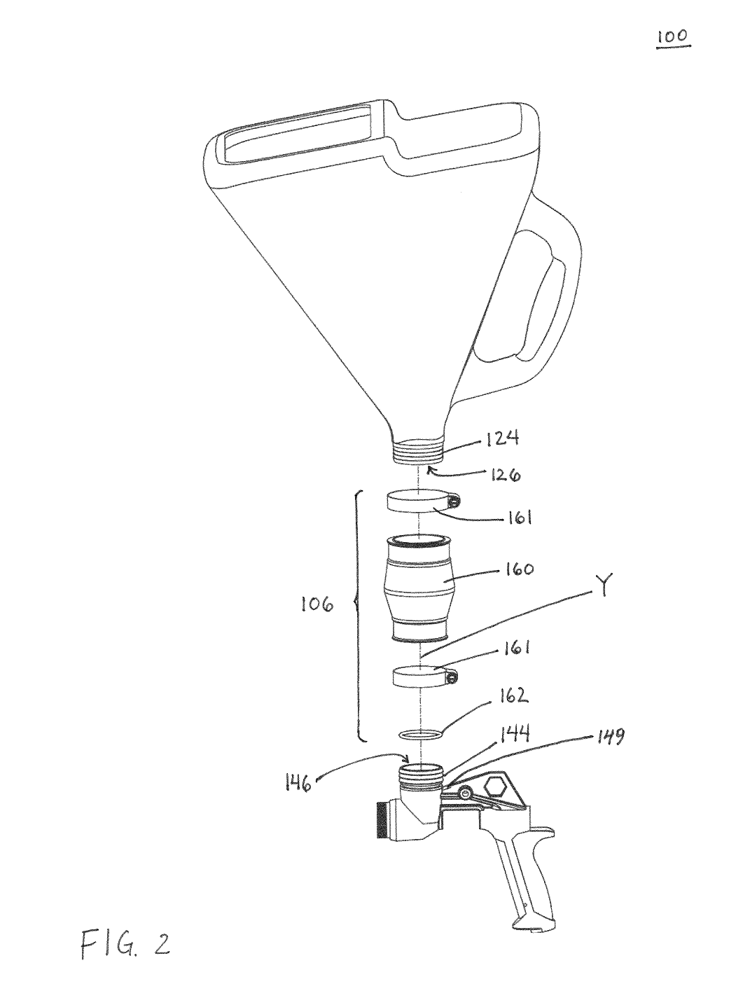

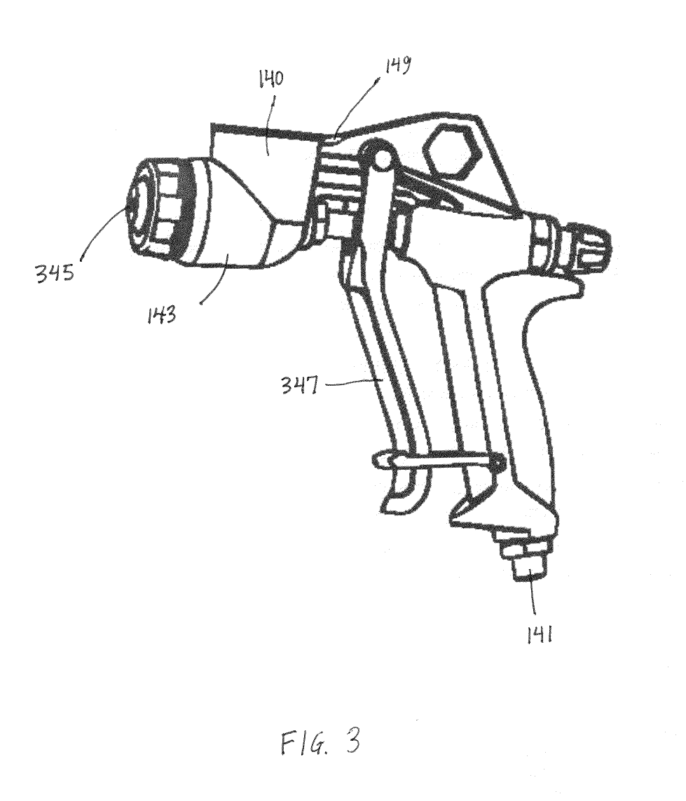

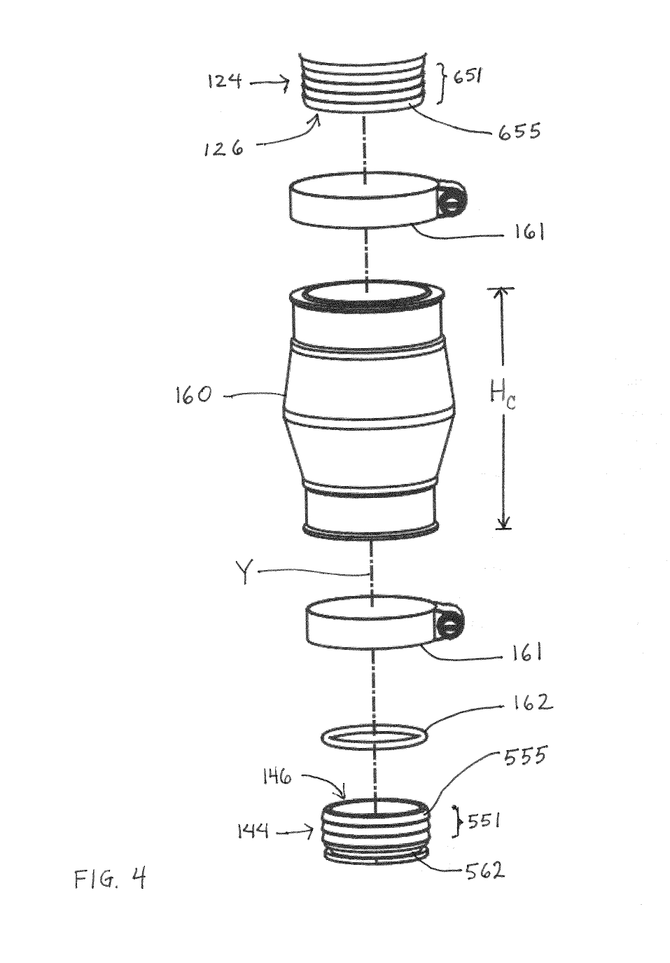

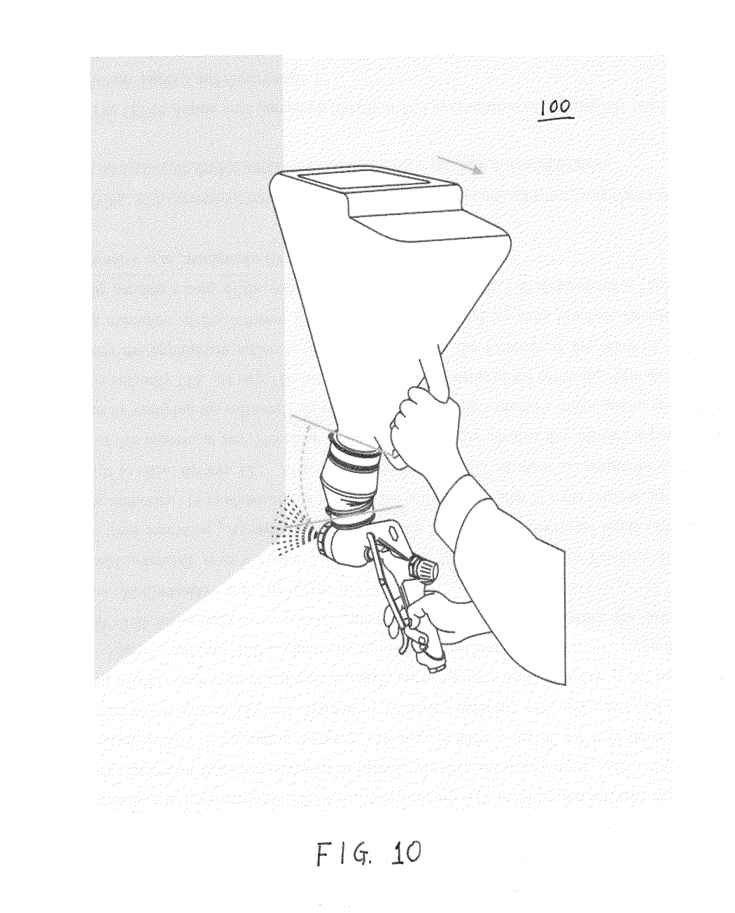

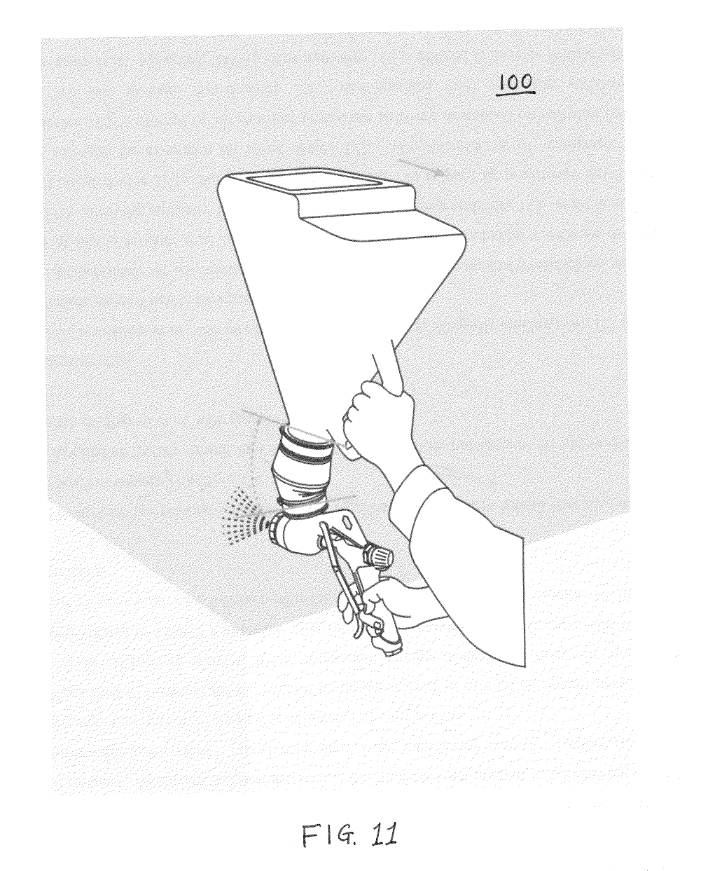

With initial reference to FIGS. 1-4, 10 and 11, the structure and construction of a hopper gun 100 in accordance with some embodiments will be described. FIG. 1 is a schematic diagram showing a perspective view of a hopper gun (in an assembled state), in accordance with some embodiments of the present disclosure. FIG. 2 is a schematic diagram showing an exploded, perspective view of a hopper gun, in accordance with some embodiments of the present disclosure; accordingly, FIG. 2 shows a hopper gun in an unassembled state. FIG. 3 is a schematic diagram showing a perspective view of a gun assembly of a hopper gun, but without the neck of the gun assembly, in accordance with some embodiments of the present disclosure. FIG. 4 is a schematic diagram showing a fragmentary, close-up, exploded perspective view of a portion of the hopper gun shown in FIG. 2, the illustrated portion including the connector, the neck of the hopper assembly, the neck of the gun assembly, and associated elements of the hopper gun pertaining to the connection of the hopper assembly and the gun assembly, in accordance with some embodiments of the present disclosure. FIG. 10 is a schematic diagram illustrating use of a hopper gun in a tight space, showing flexing of the connector, whereby the orientation of the hopper assembly and the orientation of the gun assembly can be (and as illustrated, are) varied relative to one another to facilitate access to the tight space, and also showing the design of the feed opening in the top of the hopper, whereby the likelihood of spilling of the hopper contents is reduced when the hopper is shifted rearward relative to the gun assembly, in accordance with some embodiments of the present disclosure. FIG. 11 is a schematic diagram illustrating use of a hopper gun to apply material to a ceiling, showing flexing of the connector, whereby the orientation of the hopper assembly and the orientation of the gun assembly can be (and as illustrated, are) varied relative to one another to facilitate application of the material on the ceiling, and also showing the design of the feed opening in the top of the hopper, whereby the likelihood of spilling of the hopper contents is reduced when the hopper is shifted rearward relative to the gun assembly, in accordance with some embodiments of the present disclosure. It will be understood that certain elements of the hopper gun may be omitted in these figures. Such omissions will be noted in the discussion below, as warranted.

As seen in FIGS. 1 and 2, hopper gun 100 includes a hopper assembly 102, a gun assembly 104, and a connector assembly 106. Gun assembly 104 may also be referred to as applicator 104. Connector assembly 106 may be disposed (disposable) between and configured to establish communication between hopper assembly 102 and gun assembly 104. Connector assembly 106 may be removably connected (connectable) to hopper assembly 102 and to gun assembly 104, and thus may removably connect hopper assembly 102 to gun assembly 104. (With regard to terminology, if it is said that element A is (removably) connectable with element B (or the like), then it is to be understood that element B is also (removably) connectable with element A (or the like). It is further to be understood that these expressions are equivalent to saying that element A and element B are (removably) interconnectable (or the like).) While the description herein may at times assume that hopper gun 100 or elements thereof are in an assembled state, or that hopper gun 100 or elements thereof are in a disassembled state, it is to be understood that hopper gun 100 may be unassembled, assembled, disassembled, and reassembled, as will be understood from the present disclosure. Hopper gun 100 may be a portable, hand-held device. Hopper assembly 102, gun assembly 104, and connector assembly 106 will be described below in sequence.

First, hopper assembly 102 of hopper gun 100 will be described, with primary reference to FIGS. 1, 2, 10 and 11. Hopper assembly 102 may include hopper (or reservoir) 120, feed opening 122, hopper neck 124, discharge port 126, and handle 128. Hopper 120 serves to receive and contain a material (not shown), which may be applied on a surface, and to supply the material to gun assembly 104, via connector assembly 106, as will be explained. The material may be fed into hopper 120 via feed opening 122, which may be located at the top of hopper 120 and may be deemed part of hopper 120. The material may be supplied to gun assembly 104 via discharge port 126, which may be disposed at the bottom of hopper neck 124 and may be deemed part of hopper neck 124.

As shown, e.g., in FIGS. 1 and 2, hopper 120 may have a shape the cross-section of which decreases in the downward direction (as shown in FIGS. 1 and 2), that is, in the direction going from feed opening 122 to discharge port 126. Such a shape may be or resemble an inverted square pyramid. However, hopper 120 need not have such shape or such decreasing cross-section.

Feed opening 122 may be an opening or hole covering all or (as shown, e.g., in FIGS. 1 and 2) a portion of top 125 of hopper 120. In particular, as shown, e.g., in FIGS. 1 and 2, feed opening 122 may be an opening in the front or forward portion of top 125, with a lip or rim 127 around the opening. In this regard, the front or forward side of top 125 is the side toward nozzle 345, as opposed to the side toward handle 148, of gun assembly 104 (in FIGS. 1 and 2 the front or forward side is the left side) (nozzle 345 and handle 148 will be described in the description of gun assembly 104 below). Designing feed opening 122 as an opening in the front or forward side of top 125 of hopper 120 may serve to prevent or reduce spilling out of material from hopper 120 when hopper 120 is made to lean backward (i.e., rightward and downward, toward the illustrated user, in the direction of the solid arrow shown toward the top of FIGS. 10 and 11), for example, in order to facilitate access to a tight space or to facilitate application of the material on a ceiling, as shown in FIGS. 10 and 11, respectively. In this regard, a trade-off obtains: enlarging the size (area) of feed opening 122 facilitates filling hopper 120 with material both quickly and without spillage, but reducing the size (area) of feed opening 122 helps prevent spillage of the material from hopper 120, especially when hopper 120 is full, and especially when hopper 120 is tilted rearward as described above. As noted, not only the size but also the location of feed opening 122 is a factor in preventing such spillage.

Turning to FIGS. 2 and 4, hopper neck 124 may be configured for connection to connector assembly 106, as will be described below. As shown, e.g., in FIG. 2, hopper neck 124 may have a cross-section smaller than all or most of the remainder of hopper 120, which is disposed above neck 124. Hopper neck 124 may be or resemble a cylindrical shape, as shown, e.g., in FIGS. 2 and 4. However, hopper neck 124 need not have such size of cross-section or such shape. Also, the inside shape and outside shape of hopper neck 124 may differ from one another. For example, the inside shape could be cylindrical while the outside shape could be tube-like but with a non-circular cross-section. Other shapes and combinations of shapes are possible.

Discharge port 126 may be an opening at the end of hopper neck 124 that is closest to gun assembly 104, that is, at the bottom of hopper neck 124. Such opening constituting discharge port 126 may be circular in shape, particularly where hopper neck 124, or the inside thereof, is cylindrical. Other shapes and combinations of shapes are possible.

Turning to FIGS. 1, 2, 10 and 11, handle 128 of hopper 120 may be adapted for being gripped with a hand. Handle 128 may be used to carry hopper gun 100 from place to place. As will be described below, handle 128 may also be used by a user to stabilize hopper 120, that is, both to support (the weight of) hopper 120, particularly when weighed down with material, and to hold hopper 120 upright and steady to prevent tilting thereof, which tilting could result in spillage of the contents of hopper 120 via feed opening 122. Since, as shown in FIGS. 10 and 11, a user will generally hold hopper gun 100 from behind for using hopper gun 100 for its intended purpose of applying a material to a surface, locating handle 128 on the rear of hopper 120 will generally facilitate use of handle 128 by a user, to accomplish the noted purposes. The location of handle 128 may nonetheless be varied. The design (e.g., configuration) of handle 128 may also be varied, as will be understood by one of ordinary skill in the art.

Main body 123 of hopper 120 is defined as hopper 120 excluding hopper neck 124, discharge port 126, and handle 128.

Gun assembly 104 of hopper gun 100 will now be described, with primary reference to FIGS. 2, 3 and 4. (It is noted that each of FIGS. 2 and 3 omits certain portions of gun assembly 104. For example, among other things, FIG. 2 omits the trigger and associated elements, and a portion of the nozzle visible on the exterior of gun assembly 104, while FIG. 3 omits the neck, including the material inlet port, of gun assembly 104. The depiction of gun assembly 104 in FIG. 1 is similar to that in FIG. 2, except that in FIG. 1 the neck, including the material inlet port, of gun assembly 104 is generally obscured by connector assembly 106. These portions of gun assembly 104 are explained below.) Gun assembly or applicator 104 may be a spray gun or spray applicator device, and may be referred to by such or the like names. As such, applicator 104 is employed to apply a material to a surface, by spraying the material on the surface, more specifically, by spraying a mixture of material and air (or another fluid), the material being atomized and entrained in the air. The material is supplied to applicator 104 from hopper 120. The air (or other fluid) is supplied to applicator 104 from a supply of pressurized fluid (not shown).

Applicator 104 receives the material from hopper 120 via connector assembly 106. The supply of material from hopper 120 to applicator 104 is described more specifically as follows. As seen in FIG. 2, applicator 104 includes an applicator neck 144, a material inlet port 146 disposed at the top (as defined by FIG. 2) of applicator neck 144, i.e., adjacent connector assembly 106, and a chamber 140 below (as defined by FIG. 2) applicator neck 144. Chamber 140 may be thought of as an extension of applicator neck 144. Material inlet port 146 may be deemed part of applicator neck 144. Material supplied from hopper 120, via connector assembly 106, enters applicator 104 by flowing through material inlet port 146, through applicator neck 144, and into chamber 140. The material may be supplied from hopper 120 to applicator 104, e.g., by force of gravity. Chamber 140 serves as a reservoir for receiving and containing the material supplied from hopper 120 and, as described below, for supplying the material to a stream of compressed or pressurized air (or other fluid) flowing through applicator 104.

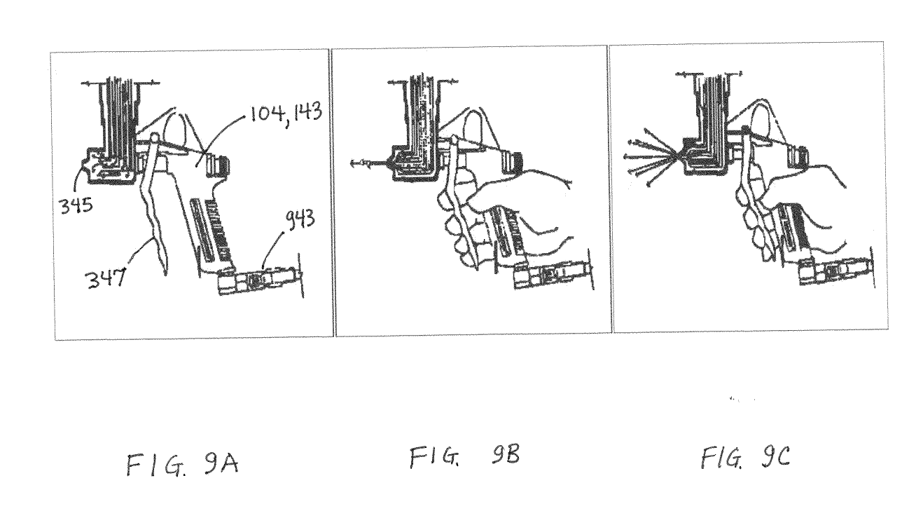

Accordingly, applicator 104 also includes a fluid inlet port 141 for receiving fluid, e.g., air, from the supply of pressurized fluid, e.g., air. Fluid inlet port 141 may be adapted for removable connection and fluid communication with the supply of pressurized fluid, e.g., via a fluid line or hose 943 (FIGS. 9A-9C). The supply of pressurized fluid may be capable of supplying fluid at a constant flow rate and pressure, and the flow rate and pressure may be selectable and controllable by a user. Applicator 104 also includes nozzle 345 and trigger 347 (FIG. 3). When fluid inlet port 141 is connected to the supply of pressurized fluid and the supply is turned on, fluid from the supply is caused to flow through applicator 104, entering via fluid inlet port 141, and travelling through a fluid passageway (not shown) in applicator 104 to nozzle 345, from which it is ejected. (For the sake of simplicity and concision, the fluid from the supply of pressurized fluid may be referred to herein as air, it being understood that the fluid may be a fluid other than air.)

Application, i.e., retracting (gripping and pulling back), of trigger 347 (shown in FIGS. 9B and 9C) causes material in chamber 140 to be brought into communication with the fluid flowing through applicator 104 to nozzle 345, for example, along the lines of the following explanation of the operation of applicator 104 as a spray applicator device. The fluid passageway may be contained at least in part inside an air stem (inside applicator 104 and hence not visible in the figures) that extends in the longitudinal direction of gun assembly 104 (considered without handle 148) (that is, in the horizontal direction in FIG. 3). The left end of the air stem contacts or seats against the entrance (not shown) to nozzle 345 when trigger 347 is in its unretracted position (shown in FIG. 9A). (It should be noted that nozzle 345 extends rightward in FIG. 3, inside applicator 104; thus, a portion of nozzle 345 is located inside applicator 104 and is not visible in the figures. The entrance to nozzle 345 is located inside applicator 104, just to the right of nozzle 345, that is, just to the right of the portion of nozzle 345 that is inside applicator 104.) When the air stem is seated against the entrance to nozzle 345, the fluid passageway in the air stem is in communication with nozzle 345 and is effectively sealed off from chamber 140 so that the contents of chamber 140 cannot come into contact with the fluid in the fluid passageway. Retracting trigger 347 causes the air stem to retract (moving rightward in FIG. 3) and become unseated from the entrance to nozzle 345, thereby opening up a space between the air stem and nozzle 345, which space may effectively be an extension of chamber 140 (the opened up space is not visible in the figures because it is inside applicator 104, but this space lies just rightward of nozzle 345). The opened up space effectively puts the fluid passageway and chamber 140 in communication with each other. Given that a stream of air is flowing through applicator 104 from fluid inlet port 141 to nozzle 345, retraction of trigger 347 thus brings the contents of chamber 140 into communication with the stream of air flowing through the opened up space, and the opened up space may serve as an atomization area in which the material is atomized by the air stream. Due, e.g., to gravity, the material in chamber 140 is drawn into the air stream, which causes the material to be atomized. The air stream including the atomized material is ejected from the nozzle as a spray, and the material entrained in the air stream is delivered and applied to the intended surface.

Applicator 104 may include a means for changing the size of the material orifice (the size of the opening of nozzle 345), for example a wheel having multiple nozzles 345 with different size openings, which may be rotated to select a nozzle opening of a given size, or some other means, as will be appreciated by one of ordinary skill in the art. Applicator 104 may also include a means for adjusting the trigger pull distance.

In the interest of concision, the above description of the operation of applicator 104 as a spray applicator device does not include all components of such a device or all aspects of such operation, since such components and aspects will be understood by one of ordinary skill in the art. One of ordinary skill in the art will also appreciate that the inventive aspects of the present disclosure may be applied to hopper guns or spray applicator devices having designs and/or modes or mechanisms of operation that vary from those described herein, including but not limited to arrangements involving gravity feed spraying, siphon feed spraying, and pressure feed spraying, and internal mix atomization and external mix atomization.

Returning to the description of the structure of applicator 104, applicator neck 144 may be configured for connection to connector assembly 106, as will be described below. Similarly to hopper neck 124, applicator neck 144 may be or resemble a cylindrical shape, as shown, e.g., in FIGS. 2 and 4. However, applicator neck 144 need not have such shape. Also, the inside shape and outside shape of applicator neck 144 may differ from one another. For example, the inside shape could be cylindrical while the outside shape could be tube-like but with a non-circular cross-section. Other shapes and combinations of shapes are possible.

Analogously to discharge port 126 of hopper assembly 102, material inlet port 146 may be an opening at the end of applicator neck 144 that is closest to hopper assembly 102, that is, at the top of applicator neck 144. Such opening constituting material inlet port 146 may be circular in shape, particularly where applicator neck 144, or the inside thereof, is cylindrical. Other shapes and combinations of shapes are possible.

Applicator 104 may include handle 148 for gripping and holding applicator 104, for example, for the purposes of carrying applicator 104 and operating applicator 104, e.g., retracting trigger 347.

Main body 143 of applicator 104 is defined as applicator 104 excluding applicator neck 144 and material inlet port 146.

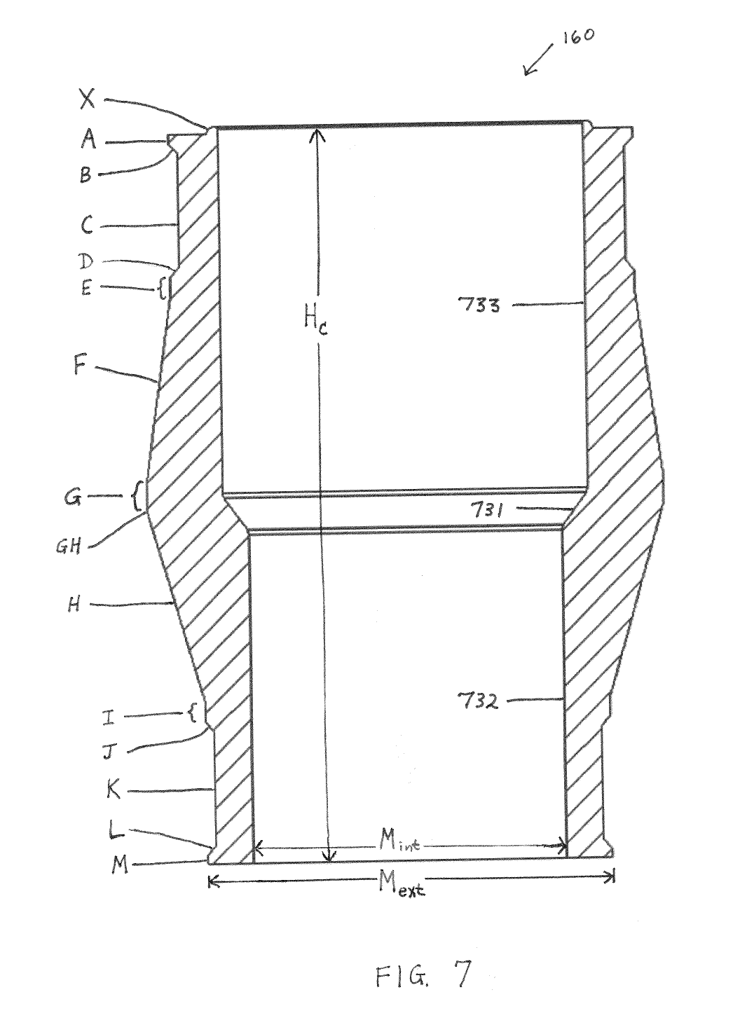

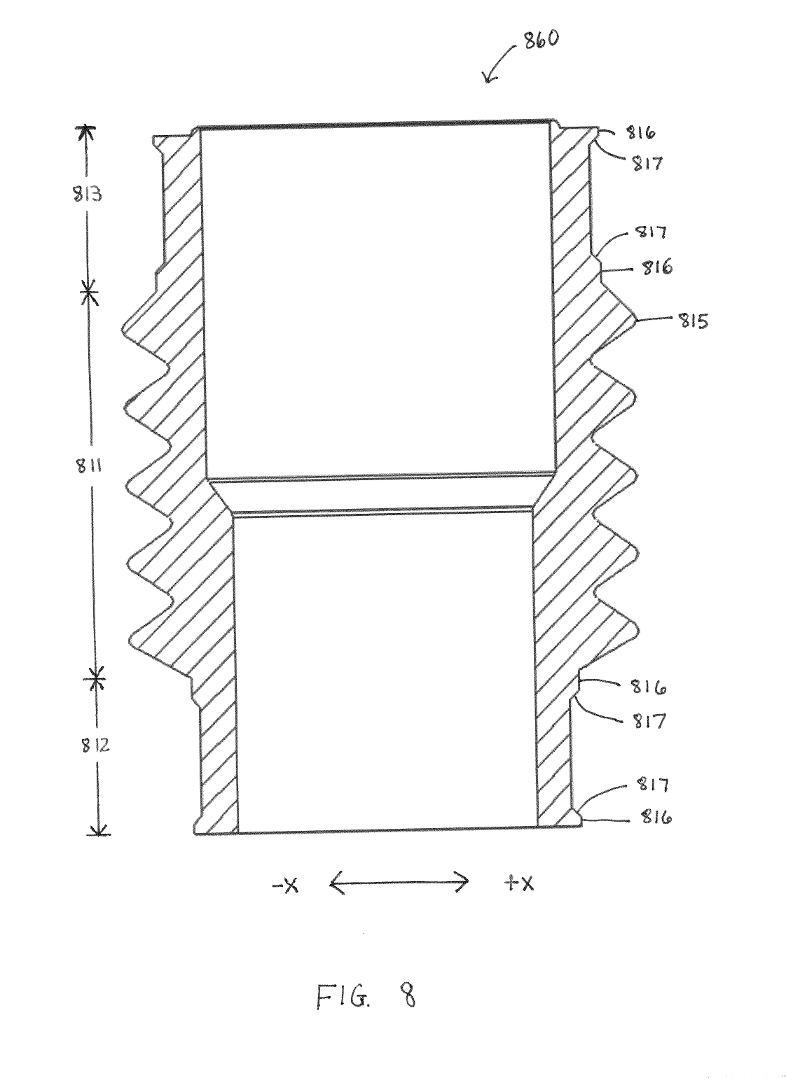

Finally, connector assembly 106 of hopper gun 100 will be described, with primary reference to FIGS. 1, 2, 4, 7 and 8. FIGS. 1, 2 and 4 have been described above. FIG. 7 is a schematic diagram showing a cutaway, or cross-sectional, view, of a connector, cut along the longitudinal axis thereof and showing, inter alia, a portion of the interior thereof, in accordance with some embodiments of the present disclosure. FIG. 8 is a schematic diagram showing a cutaway, or cross-sectional, view, of a connector, cut along the longitudinal axis thereof and showing, inter alia, a portion of the interior thereof, wherein the connector has ridges on the exterior perimeter thereof, in accordance with some alternative embodiments of the present disclosure.

As seen in FIGS. 2 and 4, connector assembly 106 includes connector 160, securing means 161 and o-ring 162. O-ring 162 is optional and, in accordance with some embodiments, is not included in connector assembly 106.

Connector 160 is configured for connection to hopper 120 and to applicator 104, or more specifically, to hopper neck 124 of hopper 120 and to applicator neck 144 of applicator 144. For example, the sizes and shapes of connector 160, hopper neck 124 and applicator neck 144 may be formed to correspond such that hopper neck 124 and applicator neck 144 fit snugly into connector 160. One side/end of connector 160, which may be designated a hopper end thereof, may be formed so that hopper neck 124 fits into it, and the other side/end of connector 160, which may be designated an applicator end thereof, may be formed so that applicator neck 144 fits into it. Thus, the hopper side/end of connector 160 may be described as being configured for connection to hopper neck 124 and also as being adjacent to and closest (along height H_{C} of connector 160) to main body 123 of hopper 120, and the applicator side/end of connector 160 may be described as being configured for connection to applicator neck 144 and also as being adjacent to and closest (along height H_{C} of connector 160) to main body 143 of applicator 104.

The connecting of connector 160 with each of hopper neck 124 and applicator neck 144 may be a tight but releasable fit. In accordance with some embodiments, each of the interior of the hopper end of connector 160, the interior of the applicator end of connector 160, the exterior of hopper neck 124, and the exterior of applicator neck 144 may have a cylindrical or substantially cylindrical shape, with the perimeter of the interior of the hopper end of connector 160 slightly exceeding the perimeter of the exterior of hopper neck 124, and the perimeter of the interior of the applicator end of connector 160 slightly exceeding the perimeter of the exterior of applicator neck 144, such that hopper neck 124 fits tightly but removably into the hopper end of connector 160 and applicator neck 144 fits tightly but removably into the applicator end of connector 160. Further details of the connection between connector 160 and (hopper neck 124 of) hopper 120 and (applicator neck 144 of) applicator 104 will be given below.

Connector 160 may have a longitudinal axis Y (extending vertically in FIGS. 2 and 4) and a height H_{C}, which is the longitudinal extent of connector 160, or equivalently the extent of connector 160 along longitudinal axis Y. According to some embodiments, connector 160 may have a modified cylindrical shape, as described below and as illustrated in the figures.

As will be understood, e.g., from FIGS. 4 and 7, at any point along height H_{C}, a cross-section of connector 160 taken perpendicularly to height H_{C} defines two circles, the circumference of one of the circles being the perimeter of the interior of connector 160 and the circumference of the other one of the circles being the perimeter of the exterior of connector 160. (To clarify, for example, in FIG. 7 the distance Mᵢₙₜ is the diameter of an interior circle at longitudinal region M, and the distance Mₑₓₜ is the diameter of an exterior circle at longitudinal region M.) Depending upon the position along height Hₑ at which the cross-section is taken, the respective sizes of the interior and exterior circles (e.g., the circumferences/diameters/areas thereof), or the length of the perimeter of the interior of connector 160 and the length of the perimeter of the exterior of connector 160, vary. (For the sake of concision, the term “perimeter” may at times be used below to refer to the length of the perimeter.) As seen in FIG. 7, the variation, along height H_{C}, of the interior perimeter is not the same as that of the exterior perimeter. In the following, the variation of the exterior perimeter will be described first, and then the variation of the interior perimeter will be described. (In the following, it is to be understood that the term “cross-section” refers to a cross-section taken perpendicularly to height H_{C} of cylinder 160, and that the terms “exterior circle” and “interior circle” may each be used as a shorthand to refer to the exterior perimeter and the interior perimeter, respectively.)

For the purpose of describing the exterior perimeter of connector 160, and the variation therein along height Hₑ of connector 160, connector 160 may be understood as being divided up into a series of contiguous longitudinal regions covering the entire height Hₑ of connector 160, for example, as follows. As seen in FIG. 7, connector 160 may be divided into 14 contiguous longitudinal regions that together extend the entire height Hₑ of connector 160. In FIG. 7, these 14 regions, from top (adjacent to main body 123 of hopper 120) to bottom (adjacent to main body 143 of applicator 104) of connector 160, are labeled X, A, B, C, D, E, F, G, H, I, J, K, L and M. (The same regions exist in FIG. 4, but are not as easily identifiable there due to the smaller size of connector 160 in FIG. 4.)

As seen in FIG. 7, the exterior perimeter of connector 160 is the greatest at the point GH where region G meets region H. Point GH is located at or near the longitudinal center of connector 160, i.e., the vertical center of height Hₑ of connector 160. Going from point GH upward, that is, toward main body 123 of hopper 120, the exterior perimeter of connector 160 decreases gradually, although not at a constant rate, until region B. Going from point GH downward, that is, toward main body 143 of applicator 104, the exterior perimeter of connector 160 decreases gradually, although not at a constant rate, until region L. The gradual decrease of the exterior perimeter going upward from point GH does not occur at the same rate, or in the same manner, as the gradual decrease of the exterior perimeter going downward from point GH. In some alternative embodiments, not illustrated, the exterior perimeter of connector 160 is the greatest over a region (i.e., along a line segment of height Hₑ), not just at a single point. For example, in such alternative embodiments, GH would refer not to a point at which regions G and H meet but rather to an extended region between (bounded by) region G (above) and region H (below).

As seen in FIG. 7, the exterior perimeter of connector 160 is the shortest at the uppermost point in region X, which is at the top of connector 160. In accordance with some alternative embodiments, not illustrated, region X is omitted, that is, connector 160 does not include region X, for example, either by forming connector 160 to have height Hₑ extend only from region M to region A, or by making the exterior perimeter of region X identical to the exterior perimeter of region A. In such alternative embodiments, the exterior perimeter of connector 160 is the shortest at region K, which is near the bottom of connector 160. In any embodiment, at any point along height H_{C} of connector 160 where the exterior perimeter is neither the greatest nor the shortest, the exterior perimeter may be referred to as “intermediate,” which term is to be understood as meaning having an extent in between that of the greatest exterior perimeter and that of the shortest exterior perimeter.

In accordance with some embodiments, the exterior perimeter of connector 160, and the variation therein along height H_{C} of connector 160, will now be described more generally and abstractly than the above description involving the 14 contiguous regions labeled X and A-M. In this more general and abstract description, connector 160 may be understood as including (at least) three longitudinal regions, which may be but are not necessarily contiguous and which may cover (extend) but do not necessarily cover (extend) the entire height H_{C} of connector 160. These three longitudinal regions are: (1) a first longitudinal region, which is a longitudinally central region, of connector 160, which excludes the top and bottom surfaces of connector 160 (i.e., in FIG. 7 the surfaces at the top of region X and at the bottom of region M, respectively), that is, the surfaces of connector 160 adjacent and closest to main body 123 of hopper 120 and to main body 143 of applicator 104, respectively, when hopper gun 100 is in the assembled state; (2) a second longitudinal region, which is a longitudinally non-central region of connector 160, and which is longitudinally closer to main body 143 of applicator 104 than is the first, longitudinally central region, when hopper gun 100 is in the assembled state (main body 143 of applicator 104 being located adjacent the bottom of connector 160 when hopper gun 100 is in the assembled state); and (3) a third longitudinal region, which is a longitudinally non-central region of connector 160, and which is longitudinally closer to main body 123 of hopper 120 than is the first, longitudinally central region, when hopper gun 100 is in the assembled state (main body 123 of hopper 120 being located adjacent the top of connector 160 when hopper gun 100 is in the assembled state). Accordingly, the first longitudinal region is located longitudinally between the second and third longitudinal regions; in terms of FIG. 7, the second longitudinal region is located below the first longitudinal region, and the third longitudinal region is located above the first longitudinal region.

It will be noted that, despite the use of the term “region,” the discussion herein is intended to encompass the limiting case in which a region corresponds to merely a point along height H_{C} of connector 160 (such as point GH, discussed above) rather than to a line segment of height H_{C} of connector 160.

It will also be noted that, with regard to any of the three longitudinal regions defined above, the exterior perimeter may vary over (i.e., within) a longitudinal region, or may be constant over a longitudinal region, as was the case with the 14 contiguous longitudinal regions described above (where, for example, as seen in FIG. 7, the exterior perimeter varies in region B but is constant in region C).

The first, longitudinally central region of connector 160 may but need not be at the exact longitudinal center of connector 160. But this first, longitudinally central region is central in the sense that there exists (a) a second, longitudinally non-central region that is closer to main body 143 of applicator 104 than is this first, longitudinally central region, when hopper gun 100 is in the assembled state, and (b) a third, longitudinally non-central region that is closer to main body 123 of hopper 120 than is this first, longitudinally central region, when hopper gun 100 is in the assembled state.

In accordance with some embodiments, the following relationships between the first, longitudinally central region, the second, longitudinally non-central region, and the third, longitudinally non-central region obtain. The exterior perimeter of connector 160 anywhere in the first, longitudinally central region thereof is greater than the exterior perimeter of connector 160 anywhere in the second, longitudinally non-central region of connector 160. (It is noted that this does not preclude the case in which there exists an additional longitudinally non-central region, for example, longitudinally between the first, longitudinally central region and the second, longitudinally non-central region, or longitudinally between the second, longitudinally non-central region and main body 143 of applicator 104, in which the exterior perimeter of connector 160 is greater than that in the first, longitudinally central region.) Similarly, the exterior perimeter of connector 160 anywhere in the first, longitudinally central region thereof is greater than the exterior perimeter of connector 160 anywhere in the third, longitudinally non-central region of connector 160. (Again, it is noted that this does not preclude the case in which there exists an additional longitudinally non-central region, for example, longitudinally between the first, longitudinally central region and the third, longitudinally non-central region, or longitudinally between the third, longitudinally non-central region and main body 123 of hopper 120, in which the exterior perimeter of connector 160 is greater than that in the first, longitudinally central region.)

In certain embodiments, however, the following arrangement obtains: the exterior perimeter of connector 160 anywhere in the first, longitudinally central region thereof is greater than the exterior perimeter of connector 160 at any other point along the longitudinal extent, that is, height H_{C}, of connector 160. This arrangement is deemed to cover both (a) the limiting case in which the first, longitudinally central region corresponds to a point (such as point GH, discussed above) and (b) the case in which the first, longitudinally central region is an extended region corresponding to a line segment along height _{HC} of connector 160 (such as where GH refers to an extended region, discussed above), and the exterior perimeter of connector 160 is constant over this extended region/line segment. This arrangement may also be described as follows: (a) the exterior perimeter of connector 160 anywhere in the first, longitudinally central region thereof (i) is greater than the exterior perimeter of connector 160 anywhere in the second, longitudinally non-central region thereof, and (ii) is greater than the exterior perimeter of connector 160 anywhere in the third, longitudinally non-central region thereof, and (b) the first, longitudinally central region, the second, longitudinally non-central region, and the third, longitudinally non-central region together cover the entire height H_{C} of connector 160. Given that the second, longitudinally non-central region is located between the first, longitudinally central region and main body 143 of applicator 104, and that the third, longitudinally non-central region is located between the first, longitudinally central region and main body 123 of hopper 120, it follows that the first, longitudinally central region is contiguous with (a) the second, longitudinally non-central region and (b) the third, longitudinally non-central region.

It will be understood that, with this arrangement (i.e., the arrangement described in the previous paragraph) connector 160 may be described as having a reverse hourglass shape, that is, the exterior perimeter of connector 160 anywhere in a longitudinally central region thereof is greater as compared to the exterior perimeter anywhere on either longitudinal side of the longitudinally central region thereof, regardless of, for example, (a) whether the longitudinally central region is at, or symmetric about, the longitudinal center of connector 160 or not, (b) whether the exterior perimeters on the two longitudinal sides of the longitudinally central region are the same or not, (c) whether any of the longitudinally central region and the regions on the two longitudinal sides thereof (i.e., the regions beginning at the respective boundaries of the longitudinally central region and ending at the top and bottom, respectively, of connector 160) have different longitudinal extents, and (d) whether the exterior perimeter is uniform over the length of any of the longitudinally central region and the regions on the two longitudinal sides thereof (as defined in (c) above). Thus, the reverse hourglass shape of connector 160 is not necessarily perfect or symmetric, but has at least the characteristic of having its exterior perimeter at a longitudinally central region thereof being greater than its exterior perimeter anywhere else along the longitudinal extent, that is, height H_{C}, of connector 160.

In some embodiments, the exterior perimeter anywhere in the second longitudinally non-central region of connector 160 is smaller than that at any other point along the height H_{C} of connector 160. In some embodiments, the exterior perimeter (at least at some points) in the second, longitudinally non-central region is intermediate (in the sense defined above). In some embodiments, the second, longitudinally non-central region is located closer to main body 143 of applicator 104 than is any other longitudinal region of connector 160, that is, the second, longitudinally non-central region is located at the bottom of connector 160.

In some embodiments, the exterior perimeter anywhere in the third longitudinally non-central region of connector 160 is smaller than that at any other point along the height H_{C} of connector 160. In some embodiments, the exterior perimeter (at least at some points) in the third, longitudinally non-central region is intermediate (in the sense defined above). In some embodiments, the third, longitudinally non-central region is located closer to main body 123 of hopper 120 than is any other longitudinal region of connector 160, that is, the third, longitudinally non-central region is located at the top of connector 160.

The above more general and abstract description stated in terms of the three longitudinal regions will now be provided with examples given in terms of the above more concrete description stated in terms of the 14 contiguous longitudinal regions. In these examples (i.e., in the examples given in the following two paragraphs), connector 160 retains the reverse hourglass shape, that is, its exterior perimeter in the first, longitudinally central region is greater than that anywhere else along its longitudinal extent, i.e., height H.

As one example, the first, longitudinally central region could correspond to the point GH, the second, longitudinally non-central region could correspond to any portions, or the entirety, of regions M, L, K, J, I and H, up to but excluding the point GH, and the third, longitudinally non-central region could correspond to any portions, or the entirety, of regions X, A, B, C, D, E, F and G, up to but excluding the point GH. As more specific examples, the second, longitudinally non-central region could correspond to region K, and the third, longitudinally non-central region could correspond to region C.

As a second example, not illustrated, the first, longitudinally central region could correspond to a portion or all of the region GH (i.e., in the scenario discussed above where GH refers to a region), even a portion that is displaced from the longitudinal center of connector 160, the second, longitudinally non-central region could correspond to any portions, or the entirety, of regions M, L, K, J, I and H (excluding a boundary, if any, between region H and region GH where the exterior perimeter equals that in region GH), and the third, longitudinally non-central region could correspond to any portions, or the entirety, of regions X, A, B, C, D, E, F and G (excluding a boundary, if any, between region G and region GH where the exterior perimeter equals that in region GH).

It may be noted in general that any of the three regions, that is, the first, longitudinally central region, the second, longitudinally non-central region, and the third, longitudinally non-central region, may itself include non-contiguous regions. For example, in the above examples, the second, longitudinally non-central region could include regions K and I, or two non-contiguous portions of region K.

In view of the above descriptions of the exterior perimeter of connector 160, in the context of the present disclosure as a whole, it will be understood that, in accordance with one or more embodiments set forth herein, connector 160 may be described as follows: (1) connector 160 has a height H_{C} and first, second and third cross-sections at three points along the height H_{C}, respectively, the first, second and third cross-sections having first, second and third exterior perimeters, respectively, and the first, second and third exterior perimeters each having a different length; (2) applicator 104 includes (a) applicator neck 144 configured for connection to connector 160 and (b) applicator main body 143 excluding applicator neck 144; hopper 120 includes (a) hopper neck 124 configured for connection to connector 160 and (b) hopper main body 123 excluding hopper neck 124; of the first, second and third cross-sections, the second cross-section is located longitudinally closest to main body 143 of applicator 104, and the third cross-section is located longitudinally closest to main body 123 of hopper 120; the first cross-section is located longitudinally (i.e., along height H_{C}) between the second cross-section and the third cross-section; the length of the exterior perimeter of the first cross-section exceeds the length of the exterior perimeter of the second cross-section; and the length of the exterior perimeter of the first cross-section exceeds the length of the exterior perimeter of the third cross-section; and (3) the length of the exterior perimeter of the first cross-section equals or exceeds the length of the exterior perimeter of any other cross-section taken along height Hₑ of connector 160. In particular, in accordance with some embodiments, connector 160 may be described as conforming to the afore-mentioned description (1) but not to the afore-mentioned descriptions (2) and (3); in accordance with some embodiments, connector 160 may be described as conforming to the afore-mentioned descriptions (1) and (2) but not to the afore-mentioned description (3); in accordance with some embodiments, connector 160 may be described as conforming to the afore-mentioned descriptions (1), (2) and (3); in accordance with some embodiments, connector 160 need not fully conform to any of the afore-mentioned descriptions (1), (2) or (3).

One of ordinary skill in the art will understand that the shape of the exterior perimeter of connector 160 may be modified from the descriptions given above. Connector 160 need not have the above-described 14 regions or the above-described three regions, or the characteristics of those regions could be varied. Connector 160 need not be characterized by having an exterior perimeter at a longitudinally central region be greater than that at some or all other regions, or by having a reverse hourglass shape. However, without being bound to theory, it is understood that the characteristics of an enlarged exterior perimeter at a longitudinally central region of connector 160 and a reverse hourglass shape of connector 160 improve hopper gun 100 by improving the ability of connector 160 to support the weight of hopper 120 (e.g., when containing material) and to maintain hopper 120 in an upright position and avoid tilting, thus reducing the chance of spillage.

FIG. 8 shows one example of a different exterior shape of a connector 860, in accordance with some alternative embodiments of the present disclosure. As shown in FIG. 8, the shape of the exterior perimeter of connector 860 generally follows that of the interior perimeter thereof, except that the exterior perimeter has a longitudinally central ridged portion 811 including ridges 815, or regions where the exterior perimeter is enlarged, the longitudinally central ridged portion 811 extending longitudinally for over half of the height of connector 860. As illustrated in FIG. 8, ridges 815 may be formed substantially in the shape of a series of equally spaced apart equilateral triangles, their bases coincident with the surface of the exterior of connector 860 and their apexes directed away from that surface (horizontally in the +x and −x directions in FIG. 8). Troughs between ridges 815 are shaped symmetrically with ridges 815, as equally spaced apart equilateral triangles having an inverted orientation relative to ridges 815. FIG. 8 shows five ridges 815 around the periphery (on the exterior surface) of connector 860, but connector 860 may have a larger or smaller number of ridges 815.

As seen in FIG. 8, connector 860 may be understood as being divided into three longitudinal regions, namely, the region of longitudinally central ridged portion 811, and two longitudinally non-central regions 812 and 813, one on either side of longitudinally central ridged portion 811, respectively. It is important to note that these three longitudinal regions 811, 812 and 813 are not necessarily the same as, that is, do not necessarily correspond to the same longitudinal regions or extents along the height of connector 860, as the first, second and third longitudinal regions discussed above with to the exterior shape of connector 160 (illustrated in FIG. 7). In each of the two longitudinally non-central regions 812 and 813 of connector 860, the exterior perimeter is constant over most of the respective region but has a step 816 including an inclined portion 817 both at the junction with the ridged portion 811 and at the bottom or top of connector 860, respectively. Despite the constancy of the exterior perimeter over most of each of the longitudinally non-central regions 812 and 813, this constant length of the exterior perimeter in longitudinally non-central region 812 is not the same as this constant length of the exterior perimeter in longitudinally non-central region 813. This constant length of the exterior perimeter in (lower) longitudinally non-central region 812 is smaller than this constant length of the exterior perimeter in (upper) longitudinally non-central region 813 (seen in FIG. 8 in that the horizontal extent of connector 860 at region 812 is smaller than the horizontal extent of connector 860 at region 813).

Ridges 815 are understood to increase the flexibility of connector 860, by facilitating bending or flexing of connector 860 at ridges 815. The desirability of such flexibility is discussed below.

The exterior shape of connector 160 (and 860) having been described, a description will now be provided of the interior shape of connector 160, with reference to FIG. 7, in accordance with some embodiments. The interior shape of connector 160 may be understood as being divided into basically three contiguous longitudinal regions, which together cover (extend) the entire height H_{C} of connector 160. These three longitudinal regions are: a first interior longitudinal region 731, which is a longitudinally central region of connector 160, which region excludes the top and bottom surfaces of connector 160, that is, the surfaces of connector 160 adjacent and closest to main body 123 of hopper 120 and to main body 143 of applicator 104, respectively; a second interior longitudinal region 732, which is a longitudinally non-central region of connector 160, and which is longitudinally closer to main body 143 of applicator 104 than is first interior longitudinal region 731 (main body 143 of applicator 104 being located adjacent the bottom of connector 160); and a third interior longitudinal region 733, which is a longitudinally non-central region of connector 160, and which is longitudinally closer to main body 123 of hopper 120 than is first interior longitudinal region 731 (main body 123 of hopper 120 being located adjacent the top of connector 160). It is important to note that first, second and third interior longitudinal regions 731, 732, and 733 are not necessarily the same as, that is, do not necessarily correspond to the same longitudinal regions or extents along height Hₑ of connector 160, as the first, second and third longitudinal regions discussed above with to the exterior shape of connector 160.

As seen in FIG. 7 (and FIG. 8), first interior longitudinal region 731 may have a relatively small longitudinal extent, and may be located at, or near, or nearly symmetric about, the longitudinal center of connector 160. Second and third interior longitudinal regions 732 and 733 may each have a relatively large longitudinal extent. The longitudinal extents of second and third interior longitudinal regions 732 and 733 may be similar in magnitude (i.e., may be similar extents of height H_{C} of connector 160). However, the relative longitudinal extents of first, second and third interior longitudinal regions 731, 732 and 733 need not be as stated here and shown in FIG. 7.

The interior of connector 160 may be a modification of a cylindrical or substantially cylindrical shape, as shown in FIG. 7 (and FIG. 8) and described below. In third interior longitudinal region 733, the interior of connector 160 may be cylindrical, and the interior perimeter (or circumference) of connector 160 may be constant, and may be greater than that in first and second interior longitudinal regions 731 and 732. In addition, in third interior longitudinal region 733, the interior perimeter (or circumference) of connector 160 may be sized to correspond to the exterior perimeter of hopper neck 124, that is, may be sized so that connector 160 may (e.g., snugly) fit over hopper neck 124, for connecting connector 160 to hopper neck 124. In second interior longitudinal region 732, the interior of connector 160 may be cylindrical, and the interior perimeter (or circumference) of connector 160 may be constant, and may be smaller than that in first and third interior longitudinal regions 731 and 733. In addition, in second interior longitudinal region 732, the interior perimeter (or circumference) of connector 160 may be sized to correspond to the exterior perimeter of applicator neck 144, that is, may be sized so that connector 160 may (e.g., snugly) fit over applicator neck 144, for connecting connector 160 to applicator neck 144. In first interior longitudinal region 731, the interior walls of connector 160 may taper or incline so as to gradually decrease the perimeter (or circumference) of connector 160 as the walls extend downward, that is toward main body 143 of applicator 104. Thus, in first interior longitudinal region 731, the interior of connector 160 may be a cylinder of gradually changing circumference. Where first interior longitudinal region 731 meets third interior longitudinal region 733, the interior perimeter (or circumference) of connector 160 may be equal to that in third interior longitudinal region 733. Where first interior longitudinal region 731 meets second interior longitudinal region 732, the interior perimeter (or circumference) of connector 160 may be equal to that in second interior longitudinal region 732. Thus, perimeter (or circumference) of connector 160 in first interior longitudinal region 731 gradually changes from that in third interior longitudinal region 733 to that in second interior longitudinal region 732 (in the downward direction) or from that in second interior longitudinal region 732 to that in third interior longitudinal region 733 (in the upward direction).

As described above, the interior cross-section or flow path in connector 160 gradually decreases in circumference in the direction of flow of material from hopper 120 to applicator 104. Hopper neck 124 has a larger circumference than applicator neck 144, and connector 160 effects a gradual transition between these two different neck sizes. This transition is part of a larger transition, beginning from hopper 120, which has the largest perimeter (albeit gradually decreasing in the direction of flow), and continuing along the flow path from hopper 120 to nozzle 345, which ultimately (at the interface between nozzle 345 and the ambient atmosphere) has the smallest perimeter along that flow path.

As described herein, material may flow under force of gravity from hopper 120, through hopper neck 124, discharge port 126, connector 106, material inlet port 146, applicator neck 144, and chamber 140, to be expelled from applicator 104 via nozzle 345 for application on a surface. In this regard, it may be preferable for the shapes of hopper 120, hopper neck 124, discharge port 126, connector 106, material inlet port 146, applicator neck 144, and chamber 140 to be such as will facilitate such gravitational flow of material, e.g., for these shapes to avoid any interior areas of repose, such as a ledge, where material could settle and accumulate, restricting such flow of material. Relatedly, it will be understood that, given the desirability of hopper 120 being large enough to contain an amount of material sufficient to avoid the need of frequent refilling, the flow of material from hopper 120 through the various components as described herein and ultimately out through nozzle 345 follows a flow path that, as indicated, narrows or becomes constricted going from hopper 120 to nozzle 345. It may be preferable that the narrowing or constricting (i.e., the reduction of the cross-sectional area) of this flow path between hopper 120 and nozzle 345 be effected in a gradual manner. Such gradual reduction of the cross-sectional area of the flow path may involve, e.g., inclined areas where the flow of material may be constricted to a limited degree, but it may be preferable to avoid ledges or the like (e.g., extending into the flow path in a direction perpendicular to the walls of the flow path), as stated above. An example of such an inclined area is the inclined region (of interior wall of connector 160) of first interior longitudinal region 731, shown in FIG. 7.

Nonetheless, the interior perimeter of connector 160 need not be shaped as described above. It is not necessary that second and third interior longitudinal regions 732 and 733 have constant interior perimeters, that first interior longitudinal region 731 taper, or that the relations between the lengths of the interior perimeters of first, second and third interior longitudinal regions 731, 732 and 733 be as described above. Nor is it necessary that connector 160 have first, second and third interior longitudinal regions 731, 732 and 733.

In prior art hopper guns, the connection between the hopper (assembly) and the gun (assembly) is a rigid, inflexible connection. Given the generally large and bulky size of the hopper (assembly) (explained above), this rigid, inflexible connection makes it difficult to use such a hopper gun to apply a material in a tight space or on a ceiling, and accordingly use of such a hopper gun in these applications often leads to unacceptable results. In contrast, connector 160 is preferably formed as a flexible member, that is, a member that is able to bend or flex, such that the orientation of hopper assembly 102 and the orientation of gun assembly 104 may be changed relative to each other. This flexibility is useful for a user in operating hopper gun 100, in applications such as those described above, namely, applying material in a tight space or on a ceiling, as this flexibility facilitates access to tight spaces and ceilings. FIGS. 10 and 11 illustrate these scenarios, respectively, showing connector 160 flexing (indicated by the dashed arrow) as the user pulls hopper assembly 102 rearward and downward (toward the user, in the direction of the solid arrow shown toward the top of FIGS. 10 and 11) in order to position gun assembly 104 either closer to the intended surface of application (FIG. 10) or more vertically than would otherwise be possible (FIG. 11), for more effective application in a tight space or on a ceiling, respectively. As seen in FIGS. 10 and 11, by virtue of the flexing of connector 160, the orientation of applicator 104 and the orientation of hopper 120 may be shifted with respect to one another.

In this regard, it may be noted that in an initial state of hopper gun 100, as shown in FIG. 1, applicator neck 144, connector 160 and hopper neck 124 are all aligned along longitudinal axis Y (illustrated in FIGS. 2 and 4). In contrast, in FIGS. 10 and 11, connector 160 is bent or flexed such that applicator neck 144 and hopper neck 124 are no longer aligned along longitudinal axis Y, and connector 160 is not itself entirely aligned with longitudinal axis Y. Rather, hopper neck 124 may be understood as having been shifted in the clockwise direction (as indicated by the solid arrow) relative to applicator neck 144, and/or applicator neck 144 may be understood as having been shifted in the counterclockwise direction relative to hopper neck 124. Similarly, the upper part of connector 160 may be understood as having been shifted in the clockwise direction (as indicated by the dashed arrow) relative to the lower part of connector 160, and/or the lower part of connector 160 may be understood as having been shifted in the counterclockwise direction relative to the upper part of connector 160. Thus, the orientation of applicator 104 and the orientation of hopper 120 have been shifted with respect to one another.

Connector 160 preferably possesses not only flexibility but also rigidity, the latter in order to adequately support the weight of hopper 120, e.g., when filled with material, and to hold hopper 120 in an upright position without letting hopper 120 tilt, in order to avoid spillage.

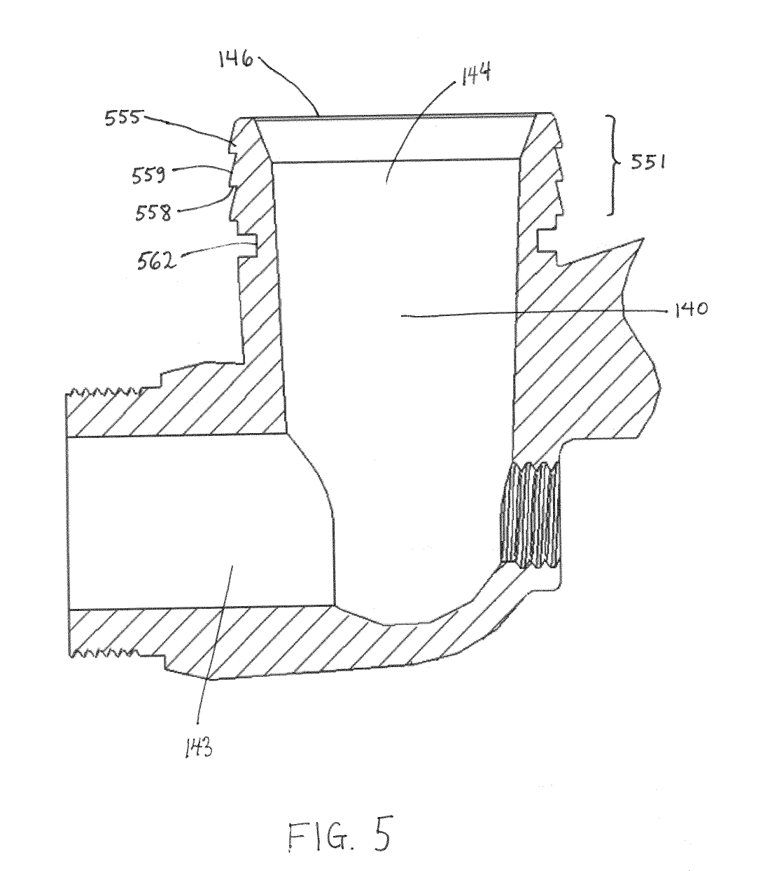

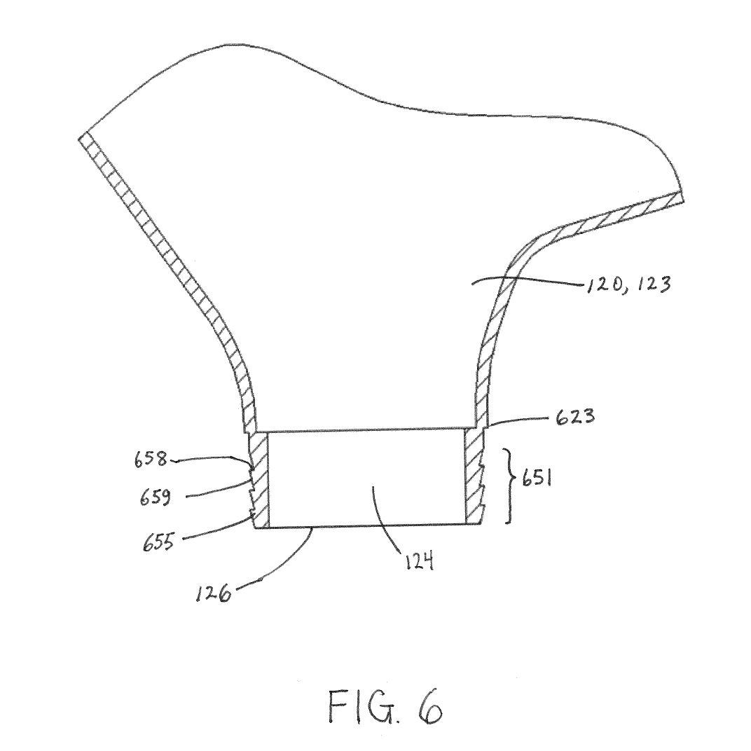

An effective combination of flexibility and rigidity may be achieved by forming connector 160 from two materials, one soft(er) and one hard(er). For example, connector 160 may be formed of a combination of rubber as a soft material and polyvinyl chloride (PVC) as a hard material. In order for connector 160 to have flexibility to flex or bend, so as to permit the orientation of hopper 120 and the orientation of gun assembly 104 to be varied relative to one another, it is also preferable for connector 160 to have at least a certain minimum length. A short length may tend to reduce the degree to which connector 160 can flex or bend. As merely one example, hopper gun 100 may have dimensions approximating the following: height of main body 123 of hopper 120: 13½ inches; height of hopper neck 124: ⅞ inches; height of ridged portion 651 (discussed below with reference to FIG. 6) on hopper neck 124: ¾ inches; height of applicator neck 144: ¾ inches; height of ridged portion 551 (discussed below with reference to FIG. 5) on applicator neck 144: 9/16 inches; height H_{C} of connector 160: 4 inches. One of ordinary skill in the art will understand that an indefinite number of other combinations of dimensions are possible, including combinations in which the relative proportions indicated above vary.

With further regard to materials of composition, hopper 120 may be made of a suitable material, e.g., a preferably lightweight material of sufficient rigidity and strength to support the load exerted thereon when filled with material for application to a surface. Examples of such materials include plastics, aluminum, fiberglass, and mixtures thereof. Applicator 104 may be made of suitable materials, e.g., the basic body thereof may be formed of a metal, e.g., stainless steel, such that applicator 104 is not damaged by ordinary operation, dis/assembly, and cleaning of hopper gun 100.

An additional problem in at least some prior art hopper guns is that the hopper (assembly) and gun (assembly) may become detached from one another, e.g., during use of hopper gun when the hopper contains material, which may result in unwanted spillage. In this regard, the flexibility of connector 160, described above, may make it more difficult to keep hopper assembly 102 and gun assembly 104 attached. In order to prevent or reduce the likelihood of hopper assembly 102 and gun assembly 104 becoming detached from one another, one or both of hopper neck 124 and applicator neck 144 may be provided with a ridged portion including one or more ridges, in accordance with some embodiments, as will be described with primary reference to FIGS. 2 and 4-6. FIGS. 2 and 4 have been described above.

FIG. 5 is a schematic diagram showing a cutaway, or cross-sectional, view, of a portion of applicator or gun assembly 104, including inter alia, applicator neck 144 having a ridged portion 551 containing ridges 555, applicator neck 144 being cut along the longitudinal axis thereof, in accordance with some embodiments of the present disclosure. FIG. 5 is simplified in that it does not necessarily include all (for example, interior) components or aspects of the illustrated portion of applicator 104. As seen most easily in FIG. 5, ridged portion 551 includes ridges (or teeth) 555 on the exterior surface of applicator neck 144. As seen most easily in FIGS. 2 and 4, absent ridges 555, the exterior surface of applicator neck 144 at ridged portion 551 would be cylindrical. Ridges 555 extend circumferentially around applicator neck 144. While three ridges 555 are shown in FIG. 5, it is possible for applicator neck 144 to have a greater or lesser number of ridges 555, as will be understood by one of ordinary skill in the art in view of the present disclosure. As seen most easily in FIG. 5, each ridge 555 has a shorter, perpendicular side 558, perpendicular to the exterior surface of applicator neck 144, and a longer, inclined side 559, which intersects the exterior surface of applicator neck 144 at an inclined, i.e., non-perpendicular, angle. Considering ridge 555 as a tooth, shorter, perpendicular side 558 may be defined as the occluding or biting surface or side of the tooth. As will be understood by one of ordinary skill in the art in view of the present disclosure, the shape of ridge 555 may be varied. For example, the angles at which sides 558 and 559 are inclined could be varied, or the shape of ridge 555 more generally could be varied, for example, ridge 555 could have a profile in cross-section other than a triangle, in contrast to the above description and the illustration in FIG. 5. The function/functioning of ridges 555 will be described below. Applicator neck 144 also has a slot 562 for holding o-ring 162 when connector assembly 106 and gun assembly 104 are attached, as described below.

FIG. 6 is a schematic diagram showing a cutaway, or cross-sectional, view, of a hopper 120, including inter alia, hopper neck 124 having a ridged portion 651 containing ridges 655, hopper neck 124 being cut along the longitudinal axis thereof, in accordance with some embodiments of the present disclosure. (It will be noted that the illustration of hopper 120 in FIG. 6 differs from that in the other figures in certain details, e.g., the shape of hopper 120; as these differences are largely not pertinent to the immediate discussion, they are disregarded except where pertinent, and the same reference numerals are used to refer to the hopper and its parts illustrated in FIG. 6 as for the hopper and its parts illustrated in the other figures.) As seen most easily in FIG. 6, ridged portion 651 includes ridges (or teeth) 655 on the exterior surface of hopper neck 124. As seen most easily in FIGS. 2 and 4, absent ridges 655, the exterior surface of hopper neck 124 at ridged portion 651 would be cylindrical. Ridges 655 extend circumferentially around hopper neck 124. While three ridges 655 are shown in FIG. 6, it is possible for hopper neck 124 to have a greater or lesser number of ridges 655, as will be understood by one of ordinary skill in the art in view of the present disclosure. As merely one example, FIG. 4 shows ridged portion 651 of hopper neck 124 having four ridges 655. Returning to FIG. 6, each ridge 655 has a shorter, perpendicular side 658, perpendicular to the exterior surface of hopper neck 124, and a longer, inclined side 659, which intersects the exterior surface of hopper neck 124 at an inclined, i.e., non-perpendicular, angle. (Sides 658 and 659 are not easily seen in FIGS. 2 and 4.) Considering ridge 655 as a tooth, shorter, perpendicular side 658 may be defined as the occluding or biting surface or side of the tooth. As will be understood by one of ordinary skill in the art in view of the present disclosure, the shape of ridge 655 may be varied. For example, the angles at which sides 658 and 659 are inclined could be varied, or the shape of ridge 655 more generally could be varied, for example, ridge 655 could have a profile in cross-section other than a triangle, in contrast to the above description and the illustration in FIG. 6. In some embodiments, not illustrated, the bottom ridge on hopper neck 124 (i.e., the ridge closest to gun assembly 104 when hopper gun 100 is assembled) has a larger exterior perimeter than the other ridges, for example, the exterior perimeter of hopper neck 124 may be made larger at the longitudinal location of the bottom ridge such that the bottom ridge has a larger exterior perimeter. The function/functioning of ridges 655 will be described below.

It should be noted that ridges 555 of applicator neck 144 are oriented in opposed fashion to ridges 655 of hopper neck 124. Specifically, ridges 555 of applicator neck 144 are inclined in the direction away from hopper 120 (i.e., downward), while ridges 655 of hopper neck 124 are inclined in the direction away from gun assembly 104 (i.e., upward). That is to say, on applicator neck 144, shorter, perpendicular side 558 (occluding surface) is on (forms) the bottom of ridge (tooth) 555, while longer, inclined side 559 is on (forms) the top of ridge (tooth) 555; in contrast, on hopper neck 124, shorter, perpendicular side 658 (occluding surface) is on (forms) the top of ridge (tooth) 655, while longer, inclined side 659 is on (forms) the bottom of ridge (tooth) 655. (“Bottom” and “top” are here used in the sense shown in the figures; “bottom” refers to the side/end nearer gun assembly 104/farther from hopper assembly 102, and “top” refers to the side/end nearer hopper assembly 102/farther from gun assembly 104. It is to be understood that the usage “inclined in the direction away from hopper 120 (i.e., downward)” is hereby defined to mean that, of the two sides of the tooth (ridge 555), the occluding side (surface) faces away, or is farther away, from hopper 120 (faces downward), and the usage “inclined in the direction away from gun assembly 104 (i.e., upward)” is hereby defined to mean that, of the two sides of the tooth (ridge 655), the occluding side (surface) faces away, or is farther away, from gun assembly 104 (faces upward), as stated above and as illustrated in FIGS. 5 and 6, even though it is conceivable that these usages may be deemed arbitrary, in that opposite usages could conceivably have been employed.)

Hopper gun 100 may be sold to customers unassembled, requiring assembly by a user prior to use. After use, the user may disassemble hopper gun 100 in order to clean it, and then reassemble hopper gun 100 prior to subsequent use. In accordance with some embodiments, assembly and disassembly of hopper gun 100 is described with primary reference to FIGS. 1-3. FIG. 1 shows hopper gun 100 in an assembled state, and FIG. 2 shows hopper gun 100 in an unassembled state.

Hopper gun 100 is assembled by attaching hopper assembly 102 and gun assembly 104 using connector assembly 106. Connector 160 is attached, at the upper end thereof as shown in FIGS. 1-3 (i.e., hopper 120 end thereof), to hopper assembly 102, or more specifically to hopper neck 124 of hopper assembly 102, and connector 160 is attached, at the lower end thereof as shown in FIGS. 1-3 (i.e., applicator 104 end thereof), to gun assembly (applicator) 104, or more specifically to applicator neck 144 of gun assembly 104. Connector 160 may be manually slid onto hopper neck 124 and applicator neck 144; put otherwise, hopper neck 124 and applicator neck 144 may be slid into connector 160. As seen in FIG. 6, where hopper 120 joins hopper neck 124, the exterior perimeter of hopper 120 may exceed that of hopper neck 124 so as to form a stopping portion 623. (Stopping portion 623 is less easily seen in FIG. 2.) At stopping portion 623, the exterior perimeter of hopper 120 exceeds the interior perimeter of connector 160 at the top thereof (e.g., at the top of region X in FIG. 7), thereby preventing hopper neck 124 from being slid more deeply into connector 160. As seen collectively in FIGS. 2, 4 and 5, o-ring 162 may be placed in slot 562 to render the attachment of connector 160 to gun assembly 104 more secure. However, o-ring 162, and accordingly slot 562 therefor, are optional. A connecting portion 149 of gun assembly 104 may serve to prevent gun assembly 104 from being slid more deeply into connector 160. In some embodiments, gun assembly 104 may be provided with a stopping portion, analogously to stopping portion 623 of hopper 120. Such a stopping portion would be formed by making the exterior perimeter of applicator neck 144 exceed the interior perimeter of connector 160 at the bottom thereof (e.g., at the bottom of region M in FIG. 7), thereby preventing applicator neck 144 from being slid more deeply into connector 160.

It is noted that when connector 160, hopper neck 124 and applicator 144 have been fit onto, or slid into, each other, as described herein, the portion of hopper neck 124 onto which (hopper end of) connector 160 is fitted may include ridged portion 651 (hence ridges 655) of hopper neck 124, and the portion of applicator neck 144 onto which (applicator end of) connector 160 is fitted may include ridged portion 551 (hence ridges 555) of applicator neck 144. That is, the area of connection at which connector 160 is connected with the two necks 124, 144 may include the areas of the two ridge portions 651, 551 of the two necks 124, 144, respectively. As a shorthand, this manner of connection may be described using the following or like language: connector 160 is configured for connection to applicator neck 144 and hopper neck 124, including ridged portions 555, 655 thereof.

After connector 160 has been slid onto hopper neck 124 and applicator neck 144, securing means 161 are installed on connector 160 at positions on connector 160 where connector 160 overlaps hopper neck 124 and applicator neck 144, that is, positions where, when hopper gun 100 is in the assembled state as shown in FIG. 1, hopper neck 124 and applicator neck 144 are located inside connector 160. Securing means 161 may be, e.g., two hose clamps, e.g., screw/band (worm gear) hose clamps, removably attachable circumferentially around connector 160 at regions of connector 160 underneath which lie hopper neck 124 and applicator neck 144, respectively, such that securing means (e.g., hose clamps) 161 effectively grip both connector 160 and hopper neck 124 and applicator neck 144 which lie underneath (within) connector 160. Such regions of connector 160 may be indented regions dimensioned to receive securing means (e.g., hose clamps) 161. For example, as shown in FIG. 7, such indented regions are longitudinal regions C and K. Regions C and K are indented in the sense that the exterior perimeter in those regions is smaller than the exterior perimeter in the regions that are longitudinally adjacent to them (namely, regions B (and A), D (and E), J (and I), and L (and M)). As will be understood by one of ordinary skill in the art in view of the present disclosure, a variety of other (e.g., latching, snapping, etc.) fasteners may be employed as securing means 161. As is the case with hose clamps, it is preferable that any such securing means be easily removable and reattachable, for ease of disassembly and (re)assembly of hopper gun 100, e.g., for the purpose of cleaning hopper gun 100 or for other purposes. With connector 160 in place around hopper neck 124 and applicator neck 144 and securing means 161 installed around connector 160, hopper gun 100 is in the assembled state as shown in FIG. 1. Disassembly of hopper gun 100 may be performed by reversing the steps engaged in assembly thereof.

Hopper gun 100 may be formed to have both applicator neck 144 having ridged portion 551 with ridges 555, and hopper neck 124 having ridged portion 651 with ridges 655. Alternatively, hopper gun 100 may be formed to have only one of the two ridged portions 551, 651, that is, only one of the two sets of ridges 555, 655, that is, to have ridges only on hopper neck 124 or only on applicator neck 144. As a further alternative, in some embodiments, hopper gun 100 may be formed not to have ridged portions 551 or 651, that is, not to have ridges 555 or 655.

As stated, ridges 555, 655 serve to prevent or reduce the likelihood of hopper assembly 102 and gun assembly 104 becoming detached from one another, or more specifically, of hopper 120 (hopper neck 124) and connector 160 becoming detached from one another, and of applicator 104 (applicator neck 144) and connector 160 becoming detached from one another. The surfaces at which connector 160 and hopper 120 (that is, hopper neck 124) contact each other when hopper gun 100 is assembled, and the surfaces at which connector 160 and applicator 104 (that is, applicator neck 144) contact each other when hopper gun 100 is assembled, may be referred to as (two pairs of) contact surfaces. These (two pairs of) surfaces are the interior surface of connector 160 over a longitudinal region at the upper end (hopper end) thereof, and the exterior surface of hopper neck 124 (a first pair of contact surfaces), and the interior surface of connector 160 over a longitudinal region at the lower end (applicator end) thereof, and the exterior surface of applicator neck 144 (a second pair of contact surfaces). Absent ridges 555, 655, these contact surfaces would be relatively smooth. Ridges 555, 655 increase the friction between the two contact surfaces in each of these pairs of contact surfaces. The increased friction makes it harder for the two surfaces in each of these pairs of contact surfaces to slide over (relative to) one another. Thus, the increased friction makes it harder to separate or detach connector 160 and hopper neck 124 from each other, and connector 160 and applicator neck 144 from each other. Accordingly, the attachment between connector 160 and hopper neck 124, and between connector 160 and applicator neck 144, is made more secure. Thus, hopper assembly 102 and gun assembly 104 are more securely attached to each other and less likely to become detached.

For example, if a force is exerted tending to pull hopper neck 124 out of connector 160, this force also tends to cause ridges 655 of hopper neck 124 to dig (bite) into, or be caught by, (the interior surface of) connector 160. In this case (assuming hopper gun 100 is upright, i.e., in a normal position for use), hopper 120 would be being pulled upward and/or connector 160 would be being pulled downward, and ridges 655 would be biting upward into the interior surface of connector 160, tending to prevent connector 160 from being slid with respect to hopper neck 124. Similarly, if a force is exerted tending to pull applicator neck 144 out of connector 160, this force also tends to cause ridges 555 of applicator neck 144 to dig (bite) into, or be caught by, (the interior surface of) connector 160. In this case (assuming hopper gun 100 is upright, i.e., in a normal position for use), gun assembly 104 would be being pulled downward and/or connector 160 would be being pulled upward, and ridges 555 would be biting downward into the interior surface of connector 160, tending to prevent connector 160 from being slid with respect to applicator neck 144. It will be noted that the fact that ridges 655 of hopper neck 124 incline upward or away from gun assembly 104 (as defined above) and that ridges 555 of applicator neck 144 incline downward or away from hopper 120 (as defined above), contribute to this phenomenon whereby ridges 655 and 555 dig (bite) into and are caught by interior surface of connector 160 in response to an attempted pulling out of hopper neck 124 and applicator neck 144, respectively, from connector 160. (As described, the direction of inclination or direction of biting opposes or acts counter to the force tending to pull the pertinent components apart.) More generally, the fact that ridges 555 and 655 are sharp and pointy, as described above and illustrated in FIGS. 5 and 6, as against having a shape (profile in cross-section) that is smoother, more rounded, or the like, also contributes to the stated phenomenon.

In particular, when connector 160 is flexed or bent, as seen, for example, at the dashed arrows in FIGS. 10 and 11, a force is exerted on the pertinent components tending to cause connector 160 and hopper assembly 102 to become detached, and tending to cause connector 160 and gun assembly 104 to become detached. As seen in FIGS. 10 and 11, when flexed, one side of connector 160 expands (longitudinally) and the circumferentially opposite side contracts (longitudinally). In the figures, the side in the background (left side as drawn) expands, and the side in the foreground (right side as drawn) contracts. Detachment of connector 160 from applicator neck 144 and hopper neck 124 may tend to occur more at the side of connector 160 that expands longitudinally than at the side that contracts longitudinally. The more connector 160 tends to be detached from applicator neck 144 or hopper neck 124, the more ridges 555 or 655 dig or bite into the interior surface of connector 160. Ridges 555, 655 are therefore particularly useful in keeping hopper gun 100 together as one piece when hopper gun 100 is employed in such applications as illustrated in FIGS. 10 and 11, namely, applying material in a tight space or on a ceiling.

For example, when using hopper gun 100 to apply a material on a ceiling, it will be desired to orient applicator 104 toward the vertical to a certain extent (while still maintaining the effect of gravity to feed material from hopper 120 into applicator 104) so that as much as possible of the material sprayed out from nozzle 345 reaches the ceiling, as understood from FIG. 11. When gun assembly 104 is oriented toward the vertical, hopper 120 will tend to fall backward (in the direction of the solid arrow shown toward the top of FIG. 11), which will tend to cause hopper neck 124 to pull upward off of connector 160. As hopper neck 124 pulls upward, ridges 655 of hopper neck 124 dig or bite into interior surface of connector 160.

With further regard to the functionality of ridges 555, 655, it will be understood that increasing the number of ridges 555, 655 will increase the friction and hence make the attachment more secure. Again, increasing the thickness of the ridges, i.e., increasing the length of short (occluding) sides 558, 658, is understood to enhance the attachment. And, as indicated above, forming ridges 555, 655 to have a sharp, pointy shape (cross-sectional profile), and to have directions of inclination (locations of biting surfaces) as described above, will similarly enhance attachment.

The problem that any two of hopper assembly 102, gun assembly 104 and connector assembly 106 may become detached from one another is also addressed by the material composition of connector 160 and the securing means (e.g., hose clamps) 161. The soft material component (e.g., rubber) of connector 160 helps let the hose clamps tightly squeeze and hence firmly grip connector 160 and hopper neck 124 and applicator neck 144 lying underneath connector 160 at the regions where the hose clamps grasp connector 160. The soft material component of connector 160 helps permit the force of the gripping hose clamps to be transferred to hopper neck 124 and applicator neck 144 lying underneath connector 160.

Operation of, or methods of using, hopper gun 100 will be described with primary reference to FIGS. 9A-9C, 10 and 11. FIGS. 9A, 9B and 9C are schematic diagrams illustrating use of hopper gun 100, showing a portion of hopper gun 100, with trigger 347 of the gun assembly in three different positions, respectively, in accordance with some embodiments of the present disclosure. FIG. 9A shows trigger 347 in a released, i.e., unretracted, position, thus shows hopper gun 100 in a state in which hopper gun 100 is not being operated to apply (spray) material. FIG. 9B shows trigger 347 in a partly retracted position, in which hopper gun is being operated to apply material, and, as shown, material is being sprayed from nozzle 345 toward a surface (not shown) on which the material is to be applied. FIG. 9C shows trigger 347 in a fully retracted position, in which hopper gun is being operated to apply material, and, as shown, material is being sprayed, at an increased rate relative to that of FIG. 9B, from nozzle 345 toward a surface (not shown) on which the material is to be applied. The way in which hopper gun 100, and in particular trigger 347, operates to spray a material on a surface using pressurized air to atomize the material has been described above in the description of gun assembly or applicator 104. As preliminaries to the spraying operation, material is fed into hopper 120 via feed opening 122 and air is supplied to applicator 104 from the supply of pressurized air, as also explained above.

Hopper gun 100 may be used to apply materials to surfaces such as walls, ceilings, and floors, whether interior or exterior, of houses, buildings, or the like. Hopper gun 100 may be used to apply, e.g., heavy or viscous materials, liquidus coating materials, or slurries. Hopper gun 100 may be used to apply a variety of kinds of coating materials, for example, aesthetic, acoustic or protective textured materials, such as drywall mud texture material, stucco material, chalk compound, plaster, popcorn texture, cork texture, sand texture, orange peel texture, other aesthetic, acoustic or protective textures, or mixtures of such materials. Hopper gun 100 is not limited to use with such materials but may be used with any material that may be gravity fed and atomized. Use of hopper gun 100 to apply a material to a surface may preferably be performed with a certain minimum flow rate and pressure of the air supply, e.g., 7 cubic feet per minute and 25 pounds per square inch. The texture achieved may be a function of several variables including, for example, air pressure, material orifice (size of nozzle opening), and trigger pull distance.

As compared with prior art hopper guns, hopper gun 100 according to embodiments of the present disclosure may be more effectively and efficiently used to apply a material in a tight space or on a ceiling, as illustrated in FIGS. 10 and 11. Examples of use of hopper gun 100 in a tight space include at a corner of two walls or of wall(s) and ceiling, in a closet, and around, behind, above or below an obstruction such as a cabinet, a sink or an appliance that is not readily movable, e.g., a furnace, water heater, or the like. In such applications, when using prior art hopper guns, due to the difficulty of optimally positioning the gun, material is often wasted by being spilled out of the feed opening of the hopper and/or unintentionally sprayed onto unintended surface areas. In contrast to prior art hopper guns, as described above, the flexibility of connector 160 permits flexing or bending of connector 160 (shown at the dashed arrows in FIGS. 10 and 11), which permits a user to change the orientation of hopper 120 and applicator 104 relative to each other, as seen in FIGS. 10 and 11. Particularly when using hopper gun 100 in a tight space or to apply material to a ceiling, this flexibility of connector 160 permits the user to more optimally orient applicator 104, including nozzle 345, relative to the surface to which material is intended to be applied, whereby material may be sprayed onto the surface with less (chance of) waste due to spillage from feed opening 122 of hopper 120 and/or inadvertent application of the material onto unintended surface areas. FIGS. 10 and 11 illustrate such more optimal orientation of applicator 104, and the changed orientation of hopper 120 relative to applicator 104. For example, using handle 128 the user is able to pull or rotate hopper 120 rearward and downward (toward the user), as indicated by the solid arrows shown toward the top of those figures. This permits the user to better orient applicator 104 relative to the surface to which the material is to be applied, because hopper 120 can be pulled out of the way.

The shift in orientation of hopper 120 and applicator 104 relative to each other may be described in terms of longitudinal axis Y. In an initial state of hopper gun 100, as shown in FIG. 1, applicator neck 144, connector 160 and hopper neck 124 are all symmetric with respect to, or aligned along, longitudinal axis Y. The change in orientation of hopper 120 and applicator 104 relative to each other may be described as a disruption of this symmetry or alignment. Thus, in FIGS. 10 and 11, connector 160 is bent or flexed such that applicator neck 144 and hopper neck 124 are no longer symmetric about, or aligned along, longitudinal axis Y, and connector 160 is not itself entirely symmetric about, or aligned with, longitudinal axis Y. Rather, hopper neck 124 has been shifted in a clockwise direction (as indicated by the solid arrow) relative to applicator neck 144, and/or applicator neck 144 has been shifted in the counterclockwise direction relative to hopper neck 124. Similarly, the upper part of connector 160 has been shifted in the clockwise direction (as indicated by the dashed arrow) relative to the lower part of connector 160, and/or the lower part of connector 160 has been shifted in the counterclockwise direction relative to the upper part of connector 160. In this way, the orientation of applicator 104 and the orientation of hopper 120 have been changed with respect to one another.

As described in detail above, the shape of connector 160, e.g., the reverse hourglass shape, including the enlarged exterior perimeter at a longitudinally central region thereof, improves support of hopper 120 and stability of hopper gun 100, permitting a user to better support the weight of hopper 120 (e.g., filled with material) and to better hold hopper 120 in a (relatively) upright position, without undesired tilting, which could lead to spillage.

As described in detail above, ridges 555 and 655 on applicator neck 144 and hopper neck 124, respectively, help keep hopper gun 100 together as one piece, that is, help prevent or reduce the likelihood of any two of hopper assembly 102, gun assembly 104 and connector assembly 106 from becoming detached from one another, as may otherwise more easily occur, due to various factors and in various scenarios, e.g., when flexing connector 160, where hopper 120 when heavily laden with material is oriented to be less even with the horizontal. To be sure, ridges 555, 655 function in concert with other features of hopper gun, e.g., securing means 161, in helping to keep hopper gun 100 together as one piece.

In light of the principles and example embodiments described and illustrated herein, it will be recognized that the example embodiments can be modified in arrangement and detail without departing from such principles. Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, unless indicated otherwise.

This disclosure may include descriptions of various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

What is claimed is:

1. A hopper gun for applying material to a surface, comprising:
an applicator, for applying material to a surface;
a hopper, for supplying the material to the applicator; and
a connector, connectable to the hopper, connectable to the applicator, and configured for establishing communication between the hopper and the applicator, whereby the material may be supplied from the hopper to the applicator,
wherein the connector is flexible, such that the orientation of the applicator and the orientation of the hopper may be varied with respect to one another.

2. A hopper gun as claimed in claim 1,
wherein the connector is formed of at least a first material and a second material,
wherein the first material is softer than the second material,
wherein the first material provides flexibility to the connector, and
wherein the second material provides rigidity to the connector.

3. A hopper gun as claimed in claim 2,
wherein the first material is rubber and the second material is polyvinyl chloride (PVC).

4. A hopper gun as claimed in claim 1,
wherein the applicator has an applicator neck, and the hopper has a hopper neck,
wherein at least one of the applicator neck and the hopper neck has a ridged portion having one or more ridges, and
wherein the connector is configured for connection to the applicator neck and the hopper neck, including the at least one ridged portion thereof.

5. A hopper gun as claimed in claim 1,
wherein the connector has a height and first, second and third cross-sections at three points along the height, respectively, the first, second and third cross-sections having first, second and third perimeters, respectively, and the first, second and third perimeters each having a different length.

6. A hopper gun as claimed in claim 1,
wherein the connector is formed as an element separate from the hopper and separate from the applicator.

7. A hopper gun as claimed in claim 1,
wherein the hopper comprises a reservoir for containing the material and a discharge port, in communication with the connector, for supplying the material to the applicator, via the connector,
wherein the applicator is a spray gun applicator device, the applicator comprising:
a material inlet port, in communication with the connector, for receiving the material supplied from the hopper, via the connector;
a fluid inlet port, configured to receive pressurized fluid from a supply of pressurized fluid;
a nozzle, for emitting a spray of material, atomized in a stream of the pressurized fluid flowing from the inlet port; and
a trigger for causing the material supplied from the hopper to be atomized in the stream of the pressurized fluid, and
wherein the connector and the hopper are removably interconnectable, and the connector and the applicator are removably interconnectable.

8. A hopper gun for applying material to a surface, comprising:
an applicator, for applying material to a surface;
a hopper, for supplying the material to the applicator; and
a connector, configured for establishing communication between the hopper and the applicator, whereby the material may be supplied from the hopper to the applicator,
wherein the applicator has an applicator neck, and the hopper has a hopper neck,
wherein at least one of the applicator neck and the hopper neck has a ridged portion having one or more ridges, and
wherein the connector is configured for connection to the applicator neck and the hopper neck, including the at least one ridged portion thereof.

9. A hopper gun as claimed in claim 8,
wherein the applicator neck has a ridged portion having one or more ridges, and the hopper neck has a ridged portion having one or more ridges.

10. A hopper gun as claimed in claim 9,
wherein the one or more ridges of the ridged portion of the hopper neck are inclined in a direction away from the applicator, and the one or more ridges of the ridged portion of the applicator neck are inclined in a direction away from the hopper.

11. A hopper gun as claimed in claim 8,
wherein the connector is flexible, such that the orientation of the applicator and the orientation of the hopper may be varied with respect to one another.

12. A hopper gun as claimed in claim 8,
wherein the connector has a height and first, second and third cross-sections at three points along the height, respectively, the first, second and third cross-sections having first, second and third perimeters, respectively, and the first, second and third perimeters each having a different length.

13. A hopper gun as claimed in claim 8,
wherein the connector is formed as an element separate from the hopper and separate from the applicator.

14. A hopper gun as claimed in claim 8,
wherein the hopper comprises a reservoir for containing the material and a discharge port, in communication with the connector, for supplying the material to the applicator, via the connector,
wherein the applicator is a spray gun applicator device, the applicator comprising:
a material inlet port, in communication with the connector, for receiving the material supplied from the hopper, via the connector;
a fluid inlet port, configured to receive pressurized fluid from a supply of pressurized fluid;
a nozzle, for emitting a spray of material, atomized in a stream of the pressurized fluid flowing from the inlet port; and
a trigger for causing the material supplied from the hopper to be atomized in the stream of the pressurized fluid, and
wherein the connector and the hopper are removably interconnectable via the hopper neck, and the connector and the applicator are removably interconnectable via the applicator neck.

15. A hopper gun for applying material to a surface, comprising:
an applicator, for applying material to a surface;
a hopper, for supplying the material to the applicator; and
a connector, configured for establishing communication between the hopper and the applicator, whereby the material may be supplied from the hopper to the applicator,
wherein the connector has a height and first, second and third cross-sections at three points along the height, respectively, the first, second and third cross-sections having first, second and third exterior perimeters, respectively, and the first, second and third exterior perimeters each having a different length.

16. A hopper gun as claimed in claim 15,
wherein the applicator includes (a) an applicator neck configured for connection to the connector and (b) a main body excluding the applicator neck,
wherein the hopper includes (a) a hopper neck configured for connection to the connector and (b) a main body excluding the hopper neck,
wherein of the first, second and third cross-sections, the second cross-section is located longitudinally closest to the main body of the applicator, and the third cross-section is located longitudinally closest to the main body of the hopper,
wherein the first cross-section is located longitudinally between the second cross-section and the third cross-section,
wherein the length of the exterior perimeter of the first cross-section exceeds the length of the exterior perimeter of the second cross-section, and
wherein the length of the exterior perimeter of the first cross-section exceeds the length of the exterior perimeter of the third cross-section.

17. A hopper gun as claimed in claim 16,
wherein the length of the exterior perimeter of the first cross-section equals or exceeds the length of an exterior perimeter of any other cross-section taken along the height of the connector.

18. A hopper gun as claimed in claim 15,
wherein the connector is connectable to the applicator and connectable to the hopper, and
wherein the connector is flexible, such that the orientation of the applicator and the orientation of the hopper may be varied with respect to one another.

19. A hopper gun as claimed in claim 15,
wherein the applicator has an applicator neck, and the hopper has a hopper neck,
wherein at least one of the applicator neck and the hopper neck has a ridged portion having one or more ridges, and
wherein the connector is configured for connection to the applicator neck and the hopper neck, including the at least one ridged portion thereof.

20. A hopper gun as claimed in claim 15,
wherein the connector is formed as an element separate from the hopper and separate from the applicator.

21. A hopper gun as claimed in claim 15,
wherein the hopper comprises a reservoir for containing the material and a discharge port, in communication with the connector, for supplying the material to the applicator, via the connector,
wherein the applicator is a spray gun applicator device, the applicator comprising:
a material inlet port, in communication with the connector, for receiving the material supplied from the hopper, via the connector;
a fluid inlet port, configured to receive pressurized fluid from a supply of pressurized fluid;
a nozzle, for emitting a spray of material, atomized in a stream of the pressurized fluid flowing from the inlet port; and
a trigger for causing the material supplied from the hopper to be atomized in the stream of the pressurized fluid, and
wherein the connector and the hopper are removably interconnectable, and the connector and the applicator are removably interconnectable.
